(19) United States
(12) Patent Application Publication
(10) Pub. No.: US 2026/0161109 A1
(43) Pub. Date: Jun. 11, 2026

(54) IMAGE FORMING APPARATUS

(71) Applicant: CANON KABUSHIKI KAISHA, Tokyo (JP)

(72) Inventors: Isamu Takeda, Tokyo (JP); Jun Hara, Kanagawa (JP); Hikaru Osada, Kanagawa (JP); Akisato Sakaki, Kanagawa (JP)

(21) Appl. No.: 19/181,666

(22) Filed: Apr. 17, 2025

(30) Foreign Application Priority Data
Apr. 24, 2024 (JP) 2024-070816

(51) Int. Cl. G03G 15/01; G03G 15/00

(52) U.S. Cl. CPC G03G 15/0173; G03G 15/50; G03G 2215/0177

(57) ABSTRACT

An image forming apparatus has a rotary in which first and second cartridges are attached. The image forming apparatus has first and second developing units. The first and second developing units include a first and second containers containing first and second developers supplied from the first and second cartridges respectively, and first and second developing members to develop electrostatic latent images formed on a photosensitive member using the first and second developers. The image forming apparatus performs at least two times an acceleration/deceleration operation in which the rotary accelerates and thereafter decelerates, during a period in which the rotary rotates from the first feeding orientation to the first developing orientation.

### BACKGROUND OF THE INVENTION

### Field of the Invention

The present invention relates to an image forming apparatus that forms an image on a recording material.

### Description of the Related Art

In the field of electrophotographic image forming apparatuses, a rotary developing method is known in which a color image is formed by rotating a rotary equipped with a plurality of developing units having a toner container and a developing container. Japanese Patent Laid-Open No. 2009-008794 describes an image forming apparatus configured such that toner falls from the toner container to the developing container when the developing unit is tilted to a predetermined angle by the rotation of the rotary, and a predetermined amount of toner is supplied to the developing container.

When forming a full-color image in an image forming apparatus equipped with such a rotary-type developing system, the rotary rotates by a predetermined angle each time an image for one page of each color is developed, and multiple transfer is executed. Therefore, the rotary rotates once to form a one-page color image, and toner is supplied from the toner container to the developing container within a predetermined rotation range during the process.

### SUMMARY OF THE INVENTION

However, if the toner container is left unused for a long period of time, the toner in the container may adhere to wall surfaces of the container, or particles of the toner adhere to each other, making it difficult to supply the toner to the developing container. Such toner adhesion may not be eliminated during normal image forming operations, and toner adhesion is particularly likely to occur in hot and humid environments. When toner adhesion occurs, the toner in the toner container is not supplied to the developing container and the toner container is replaced while the toner remains in the container, resulting in wasted toner. In contrast, it is possible to loosen adhered toner by providing an agitating member for agitating the toner in the toner container. However, this would require a larger number of parts to constitute the image forming apparatus, including the toner container, which may result in a complicated configuration. It is desirable to avoid toner wastage by preventing adhesion of toner without an agitating member in order to reduce the number of parts in the image forming apparatus, downsize the apparatus, and realize the cost reduction.

The present invention prevents adhesion of toner without an agitating member and allows toner in the toner container to be consumed without waste in an image forming apparatus equipped with a toner feeding system that supplies toner from the toner container to the developing container.

One aspect of the present invention provides an image forming apparatus to and from which a first cartridge containing a first developer and a second cartridge containing a second developer are attachable and detachable, the image forming apparatus comprising: a first developing unit including: a first container for containing the first developer supplied from the first cartridge; and a first developing member configured to develop an electrostatic latent image formed on a photosensitive member using the first developer contained in the first container; a second developing unit including: a second container for containing the second developer supplied from the second cartridge; and a second developing member configured to develop the electrostatic latent image formed on the photosensitive member using the second developer contained in the second container; a rotatable rotary including the first developing unit and the second developing unit; a drive mechanism configured to drive the rotary to rotate the rotary; and a controller configured to control the drive mechanism, wherein the first developer in the first cartridge is supplied to the first container by being discharged from a first discharge opening formed in the first cartridge to a first receiving opening formed in the first container, the rotary is configured to assume: a first feeding orientation in which a direction from the first discharge opening to the first receiving opening has a vertical downward component; and a first developing orientation in which the first developing member is capable of developing the electrostatic latent image on the photosensitive member, the controller comprises: at least one memory storing instructions; and at least one processor that is in communication with the at least one memory and that, when executing the instructions, cooperates with the at least one memory to execute processing, and the processing includes controlling the drive mechanism to perform at least two times an acceleration/deceleration operation in which the rotary accelerates and thereafter decelerates, during a period in which the rotary rotates from the first feeding orientation to the first developing orientation.

Another aspect of the invention provides an image forming apparatus comprising: a developing unit configured to develop an image using a developer; a rotary rotatably supported and configured to accommodate the developing unit and a cartridge containing a developer to be supplied to the developing unit; a vibration mechanism configured to come into contact with and move away from the rotary and impart vibration to the rotary; and a controller configured to control the vibration of the vibration mechanism, the controller comprises: at least one memory storing instructions; and at least one processor that is in communication with the at least one memory and that, when executing the instructions, cooperates with the at least one memory to execute processing, and the processing includes controlling the vibration mechanism to impart vibration to the rotary during a period in which the development unit is not developing an image.

The above configuration allows toner clumps in the image forming apparatus to be loosened without an agitator member and enables the toner in the toner container to be consumed without waste.

Further features of the present invention will become apparent from the following description of exemplary embodiments with reference to the attached drawings.

### BRIEF DESCRIPTION OF THE DRAWINGS

FIG. 1 is a schematic cross-sectional view of an outline configuration of an image forming apparatus according to Embodiment 1.

FIGS. 2A to 2D are schematic cross-sectional views of a rotary body and members therearound according to Embodiment 1.

FIGS. 3A and 3B are schematic cross-sectional views illustrating attachment and detachment of a toner cartridge to and from a rotary body 90 according to Embodiment 1.

FIGS. 4A and 4B are schematic cross-sectional views of a developing unit, a toner cartridge, and a tray according to Embodiment 1.

FIG. 5 illustrates a control unit according to Embodiment 1.

FIG. 6 shows the flow of rotary rotation control during image formation according to Embodiment 1.

FIG. 7A to 7E are schematic views showing toner cartridge orientations at toner feeding timing during image formation according to Embodiment 1.

FIG. 8 shows the flow of rotary rotation control in a rotary acceleration/deceleration operation mode according to Embodiment 1.

FIGS. 9A to 9D are schematic views showing toner cartridge orientations in the rotary operation mode according to Embodiment 1.

FIG. 10 shows the flow of rotary rotation control in a rotary operation mode according to Embodiment 2.

FIGS. 11A to 11E are schematic views showing toner cartridge orientations in the rotary operation mode according to Embodiment 2.

FIG. 12 shows the flow of rotary rotation control in the rotary operation mode according to Embodiment 3.

FIG. 13 shows the flow of rotary rotation control in the rotary operation mode according to Embodiment 4.

FIG. 14 shows the flow of control of rotary rotation and a vibration actuator in the rotary operation mode according to a variation of Embodiment 4.

FIG. 15 is a block diagram showing a configuration of the control unit.

FIGS. 16A and 16B show a mechanism of tray insertion and removal.

FIGS. 17A and 17B are flowcharts illustrating control procedures for acceleration/deceleration of the rotary.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### Embodiment 1

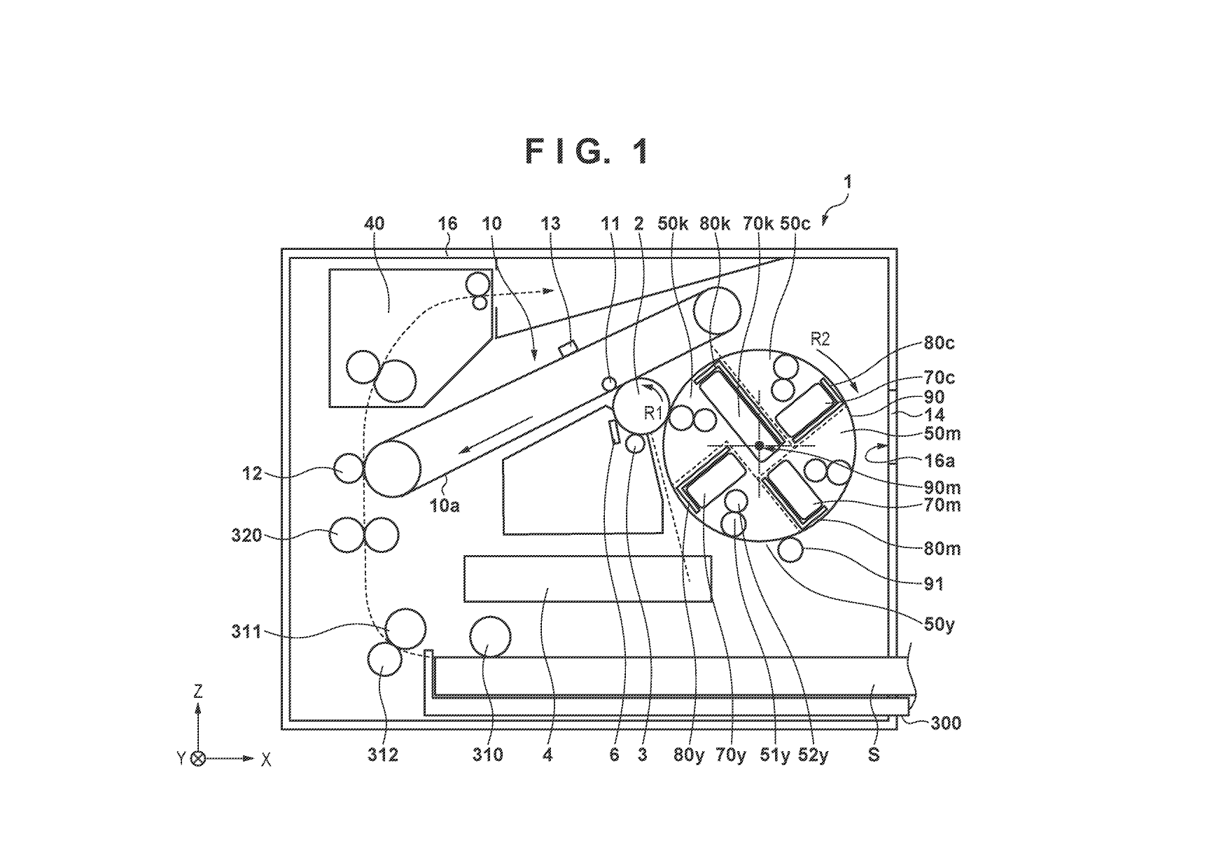

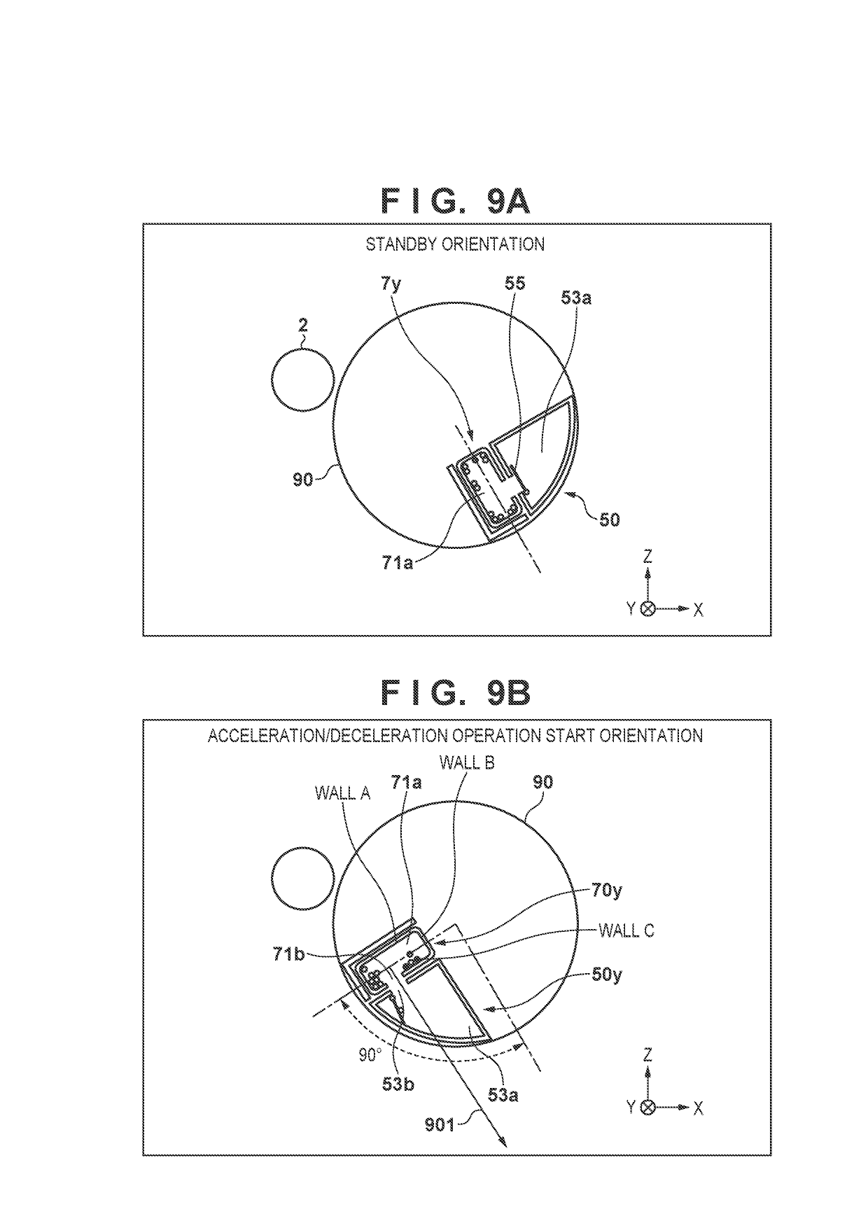

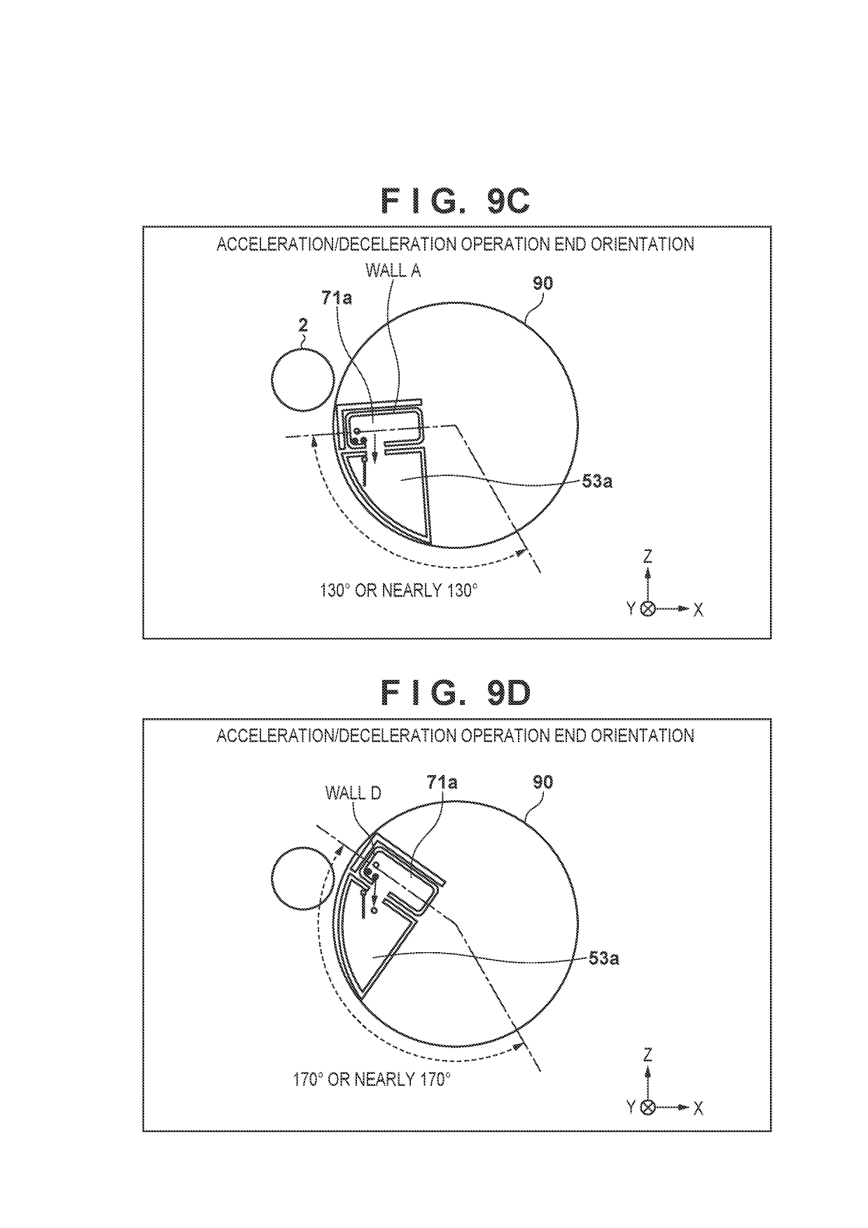

An image forming apparatus 1 according to Embodiment 1 of the present invention will be described with reference to FIGS. 1 and 9D. In the following description and drawings, the Z direction refers to the vertical direction when the image forming apparatus 1 is installed on a horizontal plane. The Y direction refers to a direction orthogonal to the Z direction and the direction of a rotation axis 90C of a later-described rotary body 90 (the direction of the rotation axis of the rotary). The X direction refers to a direction orthogonal to both the Z direction and the Y direction. The directions of arrows X, Y, and Z shown in each drawing are denoted as +X side, +Y side, and +Z side, respectively, and the opposite sides are denoted as -X side, -Y side, and -Z side, respectively.

### Overall Configuration of Image Forming Apparatus

First, an overall configuration of the image forming apparatus 1 is described. The image forming apparatus 1 is a laser beam printer that forms an image on a sheet S by an electrophotographic method. More specifically, the image forming apparatus 1 is a color laser printer of a rotary developing type that includes a rotary body 90 having four developing units 50y, 50m, 50c, and 50k. The subscripts given to the developing units 50y, 50m, 50c, and 50k indicate colors of toner. The subscripts y, m, c, and k denote yellow, magenta, cyan, and black, respectively, and a full-color image is formed by superimposing each color.

A schematic configuration and image forming operation of the image forming apparatus 1 will be described with reference to FIG. 1. FIG. 1 is a schematic view showing a cross-sectional configuration of the image forming apparatus 1.

The image forming apparatus 1 has an image forming apparatus body and toner cartridges 70y, 70m, 70c, and 70k that are attachable to and detached from the apparatus body. Each toner cartridge 70 contains toner, which is a developer. Here, the toner cartridge 70 may also be referred to simply as a cartridge. A toner cartridge using a first developer, which is a developer of a specific color, may be referred to as a first cartridge, and a toner cartridge that contains a developer in a different base from the first developer may be referred to as a second cartridge, for example. The image forming apparatus 1 includes a photosensitive drum 2 having a drum (cylindrical) shape as an image carrier or photosensitive member that forms an electrostatic latent image and carries toner that is a developer. In other words, an electrostatic latent image is formed on the photosensitive member. A charging roller 3 as a charging means, a scanner 4 as an exposure means, and a photosensitive drum cleaning unit 6 as a cleaning means are arranged around the photosensitive drum 2. An electrostatic latent image is formed on the surface of the photosensitive drum 2 that is uniformly charged by the charging roller 3, as a result of the scanner 4 emitting laser light corresponding to image information. The image forming apparatus 1 also has the developing units 50y, 50m, 50c, and 50k that develop the electrostatic latent image formed on the surface of the photosensitive drum 2 into a toner image using toner of the corresponding colors. The developing units 50y, 50m, 50c, and 50k develop the electrostatic latent image formed on the photosensitive drum 2 using yellow toner, magenta toner, cyan toner, and black toner, respectively. The developing unit 50y has a developing roller 51y and a supply roller 52y. The developing roller 51y is a developer carrier that carries toner as a developer and rotates to supply the toner to the photosensitive drum 2. The supply roller 52y is in contact with the developing roller 51y, and is a supply member that supplies toner to the developing roller 51y. The other developing units 50m, 50c, and 50k also include similar developing rollers 51m, 51c, and 51k and supply rollers 52m, 52c, and 52k. However, in FIG. 1, the developing roller 51y and the supply roller 52y are shown as representative, and the other color developing units 50m, 50c, and 50k are not assigned reference numerals. The image forming apparatus 1 also includes a sheet containing section 300, a pick-up roller 310, a feed roller 311, a separation roller 312, a transport roller pair 320, a primary transfer roller 11, a secondary transfer roller 12, a fixing device 40, and an intermediate transfer unit 10. The pick-up roller 310 is a feeding means that feeds sheets S. The feed roller 311 and the separation roller 312 constitute a separation/transport unit that transports sheets S while separating them one by one by frictional force. A toner image formed on the photosensitive drum 2 is primary transferred from the photosensitive drum 2 onto an intermediate transfer belt 10a by the primary transfer roller 11, which is disposed inside the intermediate transfer belt 10a. The secondary transfer roller 12 is a transfer means that transfers the toner image from the intermediate transfer belt 10a to a sheet S. The cleaning device 13 removes toner remaining on the intermediate transfer belt 10a after the transfer of the toner image onto the sheet S.

Note that the developing unit 50 that develops the electrostatic latent image on the photosensitive drum 2 with the aforementioned first developer may be referred to as a first developing unit, and the developing unit 50 that develops the electrostatic latent image with the second developer may be referred to as a second developing unit. Furthermore, the developing roller 51 in the first developing unit 50 may be referred to as a first developing roller, and the developing roller 51 in the second developing unit 50 may be referred to as a second developing roller.

### Rotary Configuration

A configuration of the rotary body 90 will be described with reference to FIGS. 1 to 4. As shown in FIG. 1, the rotary body 90 includes the developing units 50y, 50m, 50c, and 50k, and the toner cartridges 70y, 70m, 70c, and 70k corresponding to the respective developing units 50 are attached thereto. The toner cartridges 70y, 70m, 70c, and 70k contain yellow toner, magenta toner, cyan toner, and black toner, respectively, as toner to be fed to the developing units 50y, 50m, 50c, and 50k. Also, trays 80y, 80m, 80c, and 80k, in which the toner cartridges 70y to 70k are detachably held, are attached to the rotary body 90. The operation of attaching and detaching the toner cartridge 70 to and from the tray 80 will be described later.

The rotary body 90 is supported so as to be rotatable about a rotation axis 90C extending in the Y-axis direction, and the rotary body 90 can be rotated about the rotation axis 90C to cause any of the developing rollers 51y, 51m, 51c, and 51k to face the photosensitive drum 2. Further, the rotary body 90 is supported so as to be pivotable about a pivot shaft 91 and is always biased counterclockwise such that any of the developing rollers 51 comes into contact with the photosensitive drum 2. This causes the developing roller 51 to come into contact with the photosensitive drum 2 to form a developing nip. Note that the position of each developing unit 50 changes as the rotary body 90 rotates. The amount by which the rotary body 90 rotates is referred to as a “rotation angle”, or the like, in this embodiment. In the Z-X plane in FIG. 1, as the rotary body 90 rotates, objects included in or attached to the rotary body 90 change their positions with the rotation axis 90C as the origin, and these changes in position are represented in polar coordinates only by the changes in angular displacement. The position of the rotary body 90 indicated by an angular displacement with the rotation axis 90C as the origin is referred to as an “orientation” or “rotational phase” of the rotary body 90, or a “rotary phase”, or simply a “phase”.

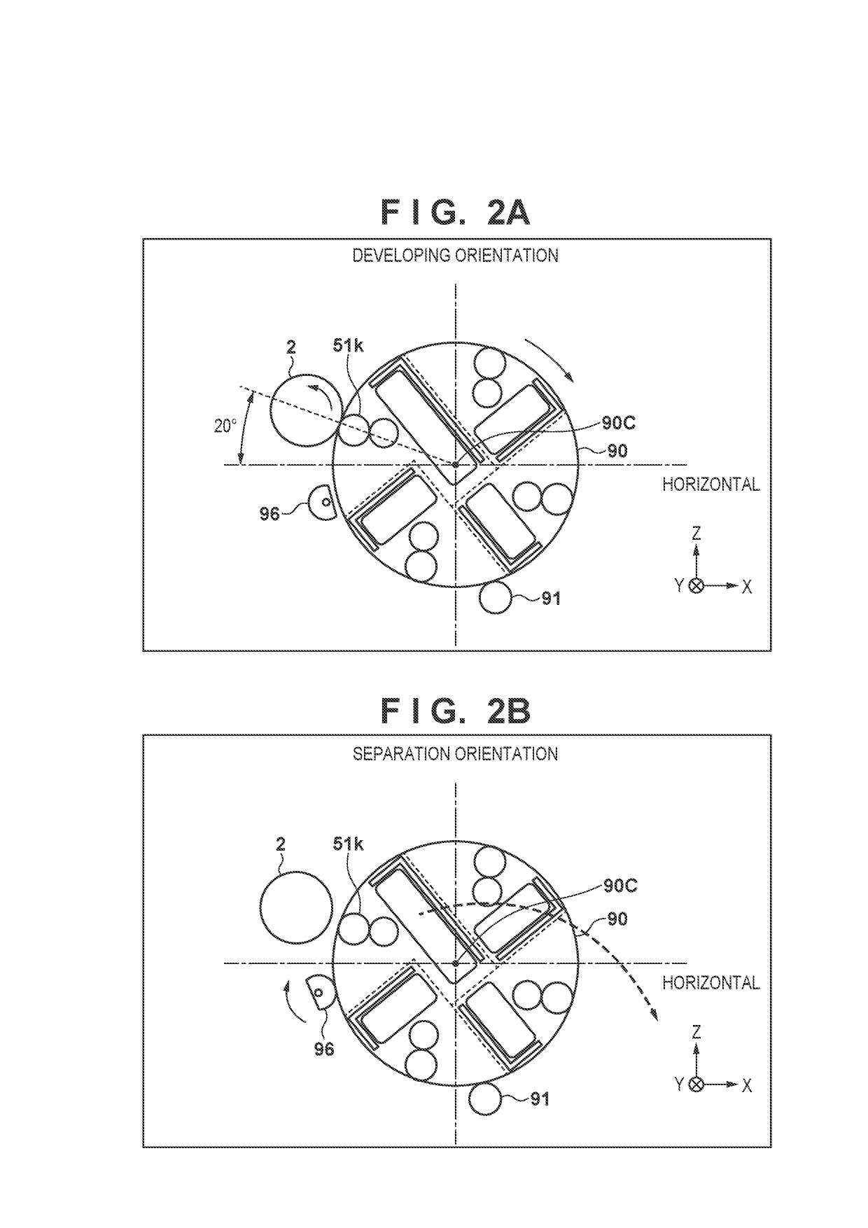

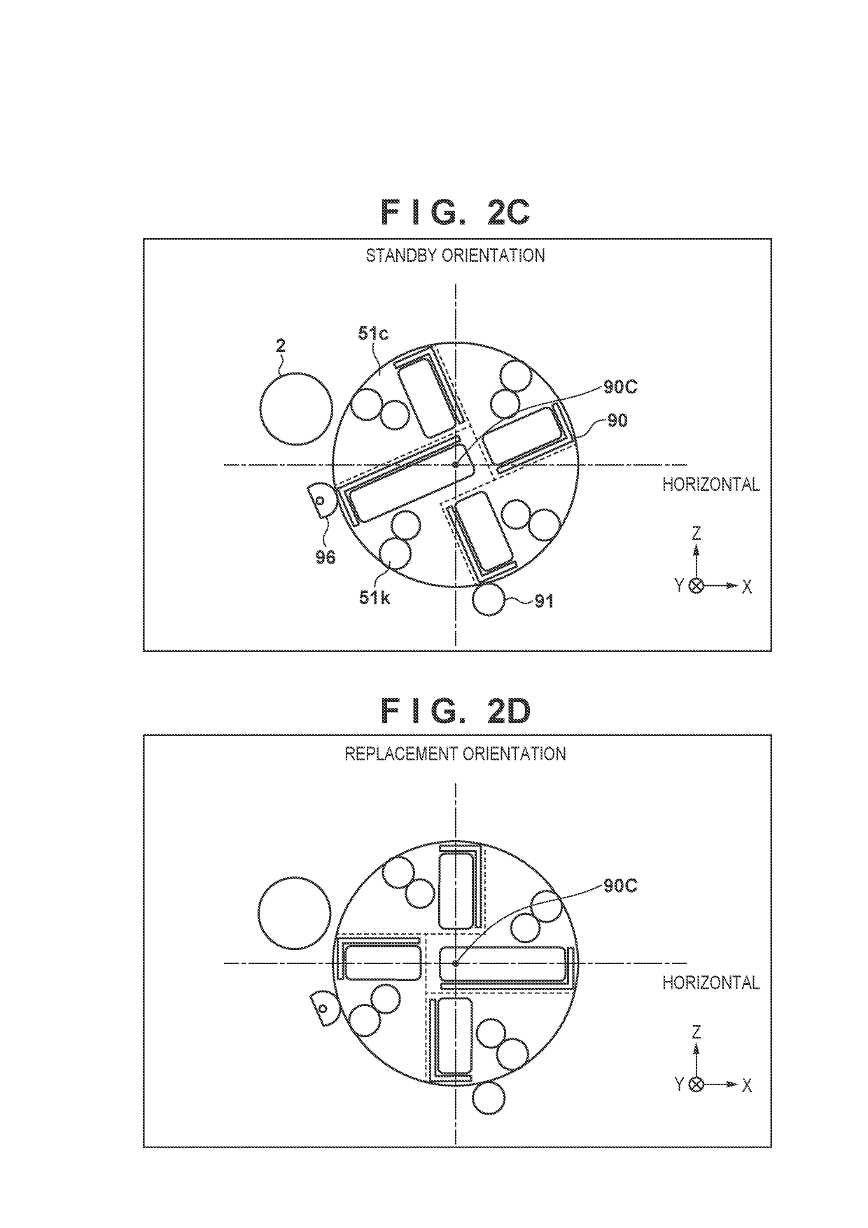

FIGS. 2A to 2D are cross-sectional schematic views of the rotary body 90 and members therearound, showing the state of contact and separation between the photosensitive drum 2 and the developing roller 51k. FIG. 2A shows a black developing orientation, in which the developing roller 51k is in contact with the photosensitive drum 2 and forms a developing nip at the position of contact. The developing orientation in this embodiment is an orientation in which the angle between a horizontal line and a line drawn from the rotation axis 90C of the rotary body 90 in FIG. 2A to the developing nip is 20 degrees when the image forming apparatus 1 is installed horizontally. In other words, it can also be said that the developing orientation is an orientation in which the angle between the plane including the rotation axis 90C of the rotary body 90 and the developing nip and the installation surface of the image forming apparatus 1 is 20 degrees. Here, the installation surface is a plane that includes a point where the image forming apparatus 1 is stably grounded, and may be paraphrased as the bottom surface of the image forming apparatus 1. In the following description, the term “horizontal” is used on the assumption that the installation surface of the image forming apparatus 1 is horizontal. Thus, the term “horizontal” can be paraphrased as “parallel to the installation surface” or “a plane parallel to the installation surface,” for example.

The orientation in which the developing roller 51y faces the photosensitive drum 2 is referred to as a “yellow developing orientation”. The orientation in which the developing roller 51m faces the photosensitive drum 2 is referred to as a “magenta developing orientation”. The orientation in which the developing roller 51c faces the photosensitive drum 2 is referred to as a “cyan developing orientation”.

On the other hand, the rotary body 90 can also be in a separated state in which none of the developing rollers 51y, 51m, 51c, and 51k is in contact with the photosensitive drum 2. As shown in FIG. 2B, a cam 96 comes into contact with the frame of the rotary body 90, and rotates the rotary body 90 about the pivot shaft 91 in the clockwise direction indicated by the dashed arrow, resulting in a state where the photosensitive drum 2 and the developing roller 51k are separated from each other.

When waiting to perform image formation, the rotary body 90 assumes a standby orientation in which the photosensitive drum 2 is positioned between the developing rollers 51c and 51k and separated from the developing rollers 51, as shown in FIG. 2C.

When the user replaces any of the toner cartridges 70, the rotary body 90 assumes a replacement orientation. FIG. 2D shows the replacement orientation for the black toner cartridge 70k. The replacement orientation for the black toner cartridge 70k is an orientation in which the black toner cartridge 70k is generally horizontal.

### Attachment and Detachment of Toner Cartridge

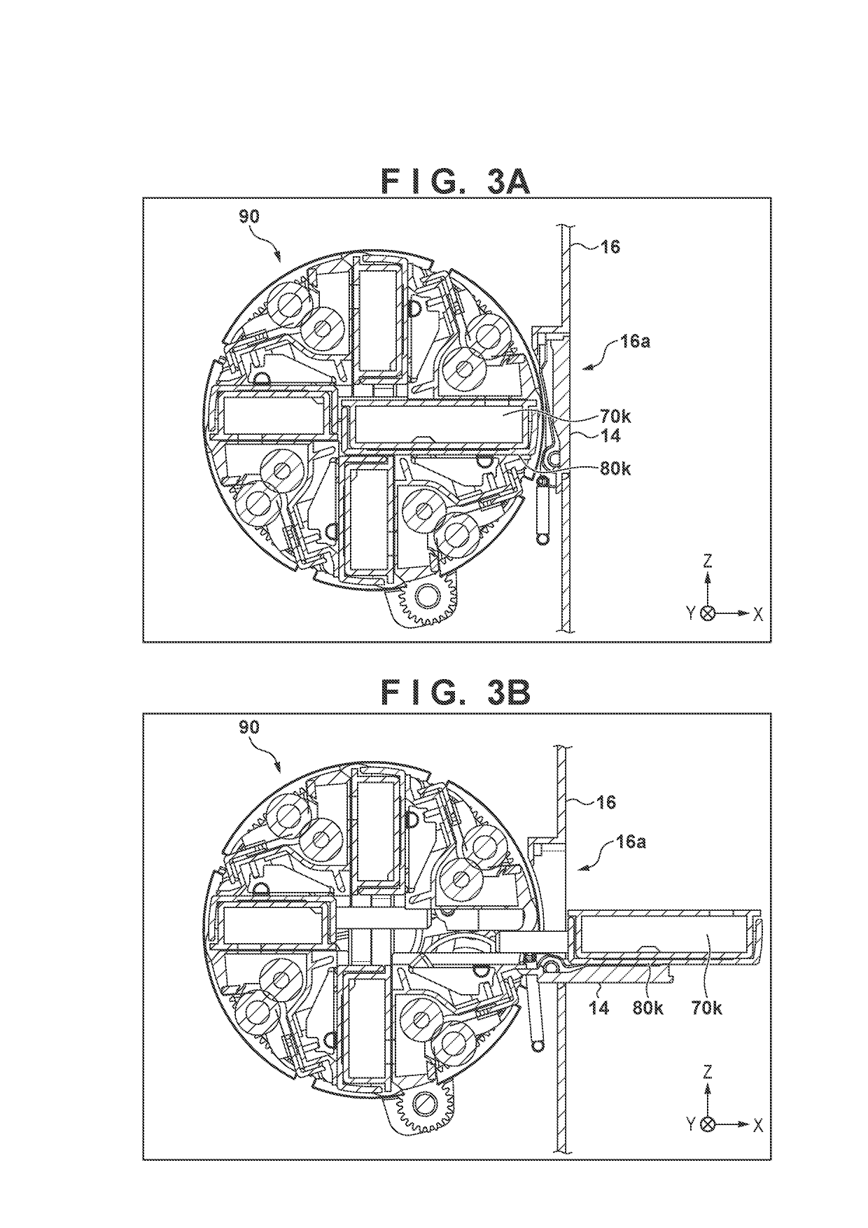

The attachment and detachment of the toner cartridge 70k to and from the rotary body 90 will be described with reference to FIGS. 3A and 3B. The image forming apparatus 1 has an opening 16a in the surface on the +X side of a housing 16. As shown in FIG. 3A, the toner cartridge 70k is stopped with the rotary body 90 in the replacement orientation for the black toner cartridge 70k in which the toner cartridge 70k faces the opening 16a and door 14 (see FIG. 1), and is supported by the tray 80k. From this state, the door 14 opens and the tray 80k slides through the opening 16a to the outside of the rotary body 90, as shown in FIG. 3B. In that state, the toner cartridge 70k can be attached to and detached from the tray 80k, i.e., the rotary body 90, and the user can replace the toner cartridge 70k.

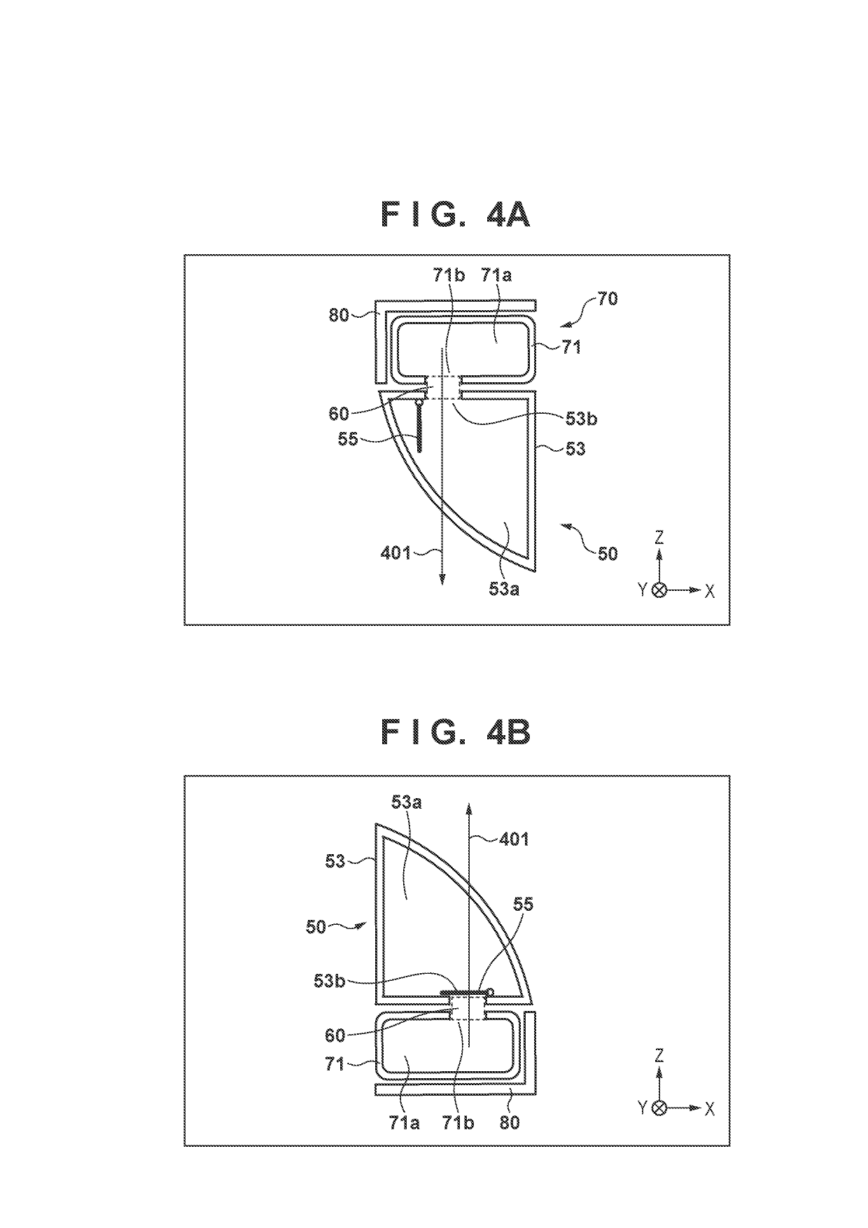

FIGS. 4A and 4B are schematic views of the developing unit, the toner cartridge, and the tray according to this embodiment. The toner cartridge 70 has a toner frame 71. The toner frame 71 has a toner containing section 71a and a discharge opening 71b in communication with the toner containing section 71a.

The developing unit 50 has a developing frame (container frame) 53. The developing frame 53 has a developing-side containing section 53a and a receiving opening 53b in communication with the developing-side containing section (toner supply chamber) 53a. Although the developing unit 50 has the developing roller 51, the supply roller 52, and so on as mentioned above, these members are omitted in FIGS. 4A and 4B. The developing-side containing section 53a of the first developing unit may be referred to as a first containing section, and the developing-side containing section 53a of the second developing unit as a second containing section, for example.

The toner cartridge 70 can move relative to the developing frame 53 to an attachment position and to a retraction position, which is the position of the toner cartridge 70 that has been retracted from the attachment position. The attachment position is the position of the toner cartridge 70 attached to the tray 80 and accommodated in the rotary body 90, as shown in FIG. 3A. The retraction position is the position of the toner cartridge 70 placed on the tray 80 that has been discharged to the outside of the rotary body 90, as shown in FIG. 3B. When the toner cartridge 70 is attached to the developing frame 53, the discharge opening 71b faces the receiving opening 53b. In other words, the toner containing section 71a of the toner cartridge 70 and the developing-side containing section 53a of the developing unit 50 are in communication with each other through a communicating section 60 (the section indicated by a broken line), which is constituted by the discharge opening 71b and the receiving opening 53b. As will be described in detail later, when toner is fed from the toner cartridge 70 to the developing unit 50, the direction of the communicating section 60 is downward in the vertical direction (-Z direction) relative to the horizontal.

It is desirable that the developing unit 50 has a sealing member 55 covering the receiving opening 53b to prevent the toner in the developing-side containing section from flowing back into the toner containing section of the toner cartridge 70. This sealing member 55 is configured to open and close as a result of being rotated with one end as an axis by gravity applied to the sealing member 55. When the direction of the communicating section 60 from the discharge opening 71b to the receiving opening 53b (indicated by arrow 401) is downward in the vertical direction (-Z direction) relative to the horizontal as shown in FIG. 4A, the sealing member opens so as not to interfere with the feeding of toner. On the other hand, when the direction of the communicating section 60 from the discharge opening 71b to the receiving opening 53b is upward in the vertical direction (+Z direction) relative to the horizontal as shown in FIG. 4B, the sealing member closes and serves as a seal.

### Control Unit and Drive Unit

As shown in FIG. 15, the image forming apparatus 1 includes a control unit 151 and motors M1, M2, and M3 as driving sources (or drive units) controlled by the control unit 151. The control unit 151 includes a memory 1512 storing a program and a CPU 1511 (or a processor), and the CPU 1511 executes the program stored in the memory 1512 to implement a control procedure for the motors or the like. As will be described later, the motor M1 supplies a driving force for rotating the rotary body 90 about the rotation axis 90C under the control of the control unit 151.

The image forming apparatus 1 also includes a drive device 98 that includes the motor M2 and a transmission device. The transmission device includes drive racks 15L and 15R serving as later-described drive gears, and a transmission unit 15t. The driving force of the motor M2 is transmitted to the drive racks 15L and 15R by the transmission unit 15t. In other words, the motor M2 is configured to drive the drive racks 15L and 15R, via which the trays 80y, 80m, 80c, and 80k are moved to be inserted into or ejected from the rotary body 90. The drive racks 15L and 15R are also collectively referred to as the drive racks 15.

The motor M3 drives members other than those driven by the motors M1 and M2. For example, the motor M3 drives the photosensitive drum 2, the developing units 50y, 50m, 50c, and 50k, the pick-up roller 310, the feed roller 311, the transport roller pair 320, the secondary transfer roller 12, the intermediate transfer belt 10a, and the fixing device 40.

Note that the members driven by the motors M1, M2, and M3 can be changed as appropriate. Also, the roles of any two or all three of the motors M1, M2, and M3 can be integrated into one motor. On the other hand, a driving source other than the motors M1, M2, and M3 may also be added.

### Replacing Operation of Toner Cartridge

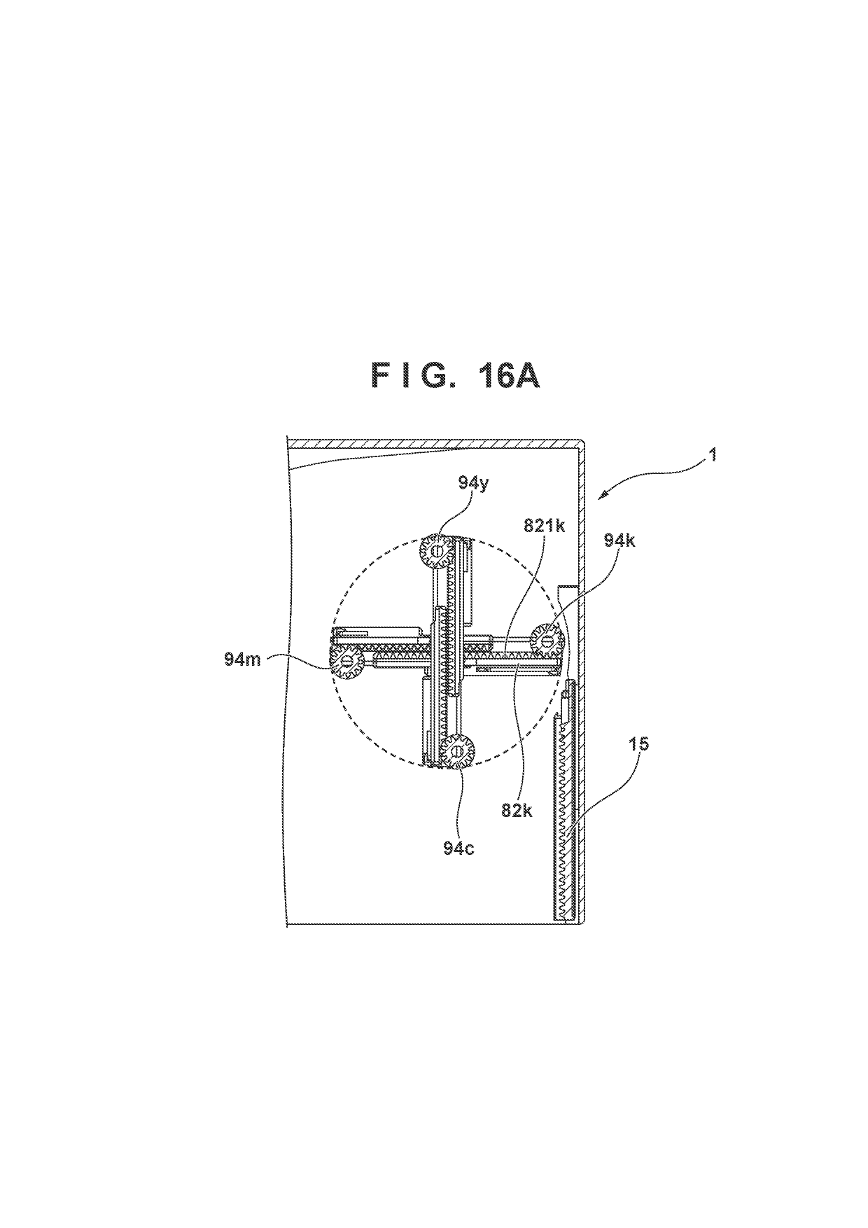

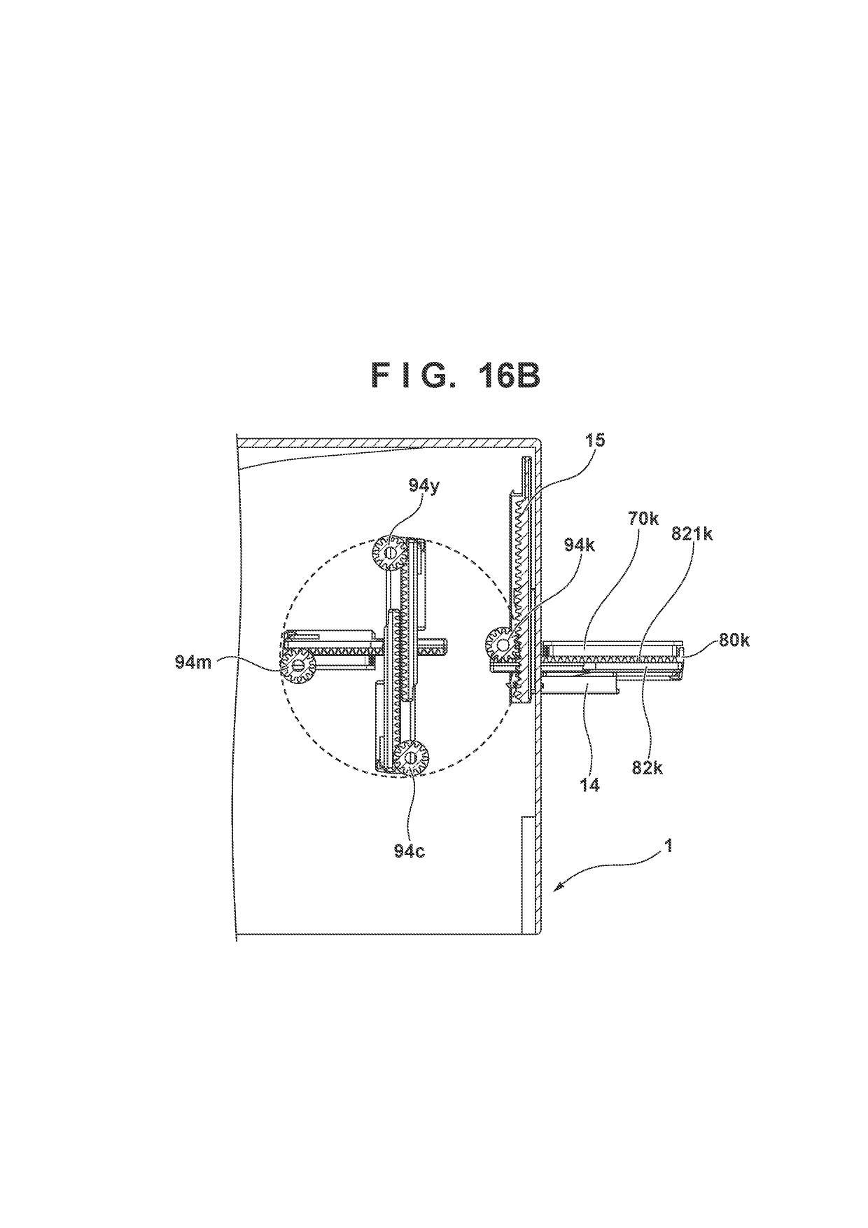

FIGS. 16A and 16B show cross sections of a region around the rotary body 90 when replacing a toner cartridge. As shown in FIG. 16B, when a toner cartridge is replaced, the user performs an operation to attach and detach the toner cartridge 70k to and from the tray 80. Thus, the entire toner cartridge 70k protrude from the front surface of the image forming apparatus 1. A toner tray detection sensor is provided, so that it is possible to determine whether the tray 80k has been inserted and completely accommodated. Although the case of the toner cartridge 70k is described as an example, the same applies to the other toner cartridges.

As an example of a drive transmission mechanism, a mechanism used in this embodiment is configured such that, for example, a rack is disposed along the sliding direction of the tray 80, and a gear engaging with the rack is driven to rotate, thereby taking in and out the tray in the replacement position or the retraction position to and from the rotary. This configuration will be described with reference to FIGS. 16A and 16B.

### Driving Configuration for Tray Insertion and Removal

A description will be given, with reference to FIGS. 16A and 16B, of a tray insertion and removal operation in which the tray 80k as an example is slid from inside the rotary body 90 (attachment position where the toner cartridge 70k is attached to the developing unit 50k) to the retraction position on the outside. The operation of inserting and removing the tray 80k is performed with the motor M2 as a driving source, the drive racks 15, the rack gears 94k, and the racks 821k. First, the drive racks 15 are slid upward relative to the image forming apparatus 1 by the driving force transmitted by the motor M2, and transmit the driving force to the rack gears 94k. The rack gears 94k rotate counterclockwise and transmit the driving force to the racks 821k, thereby sliding the tray 80k from the position where the toner cartridge 70k is attached to the developing unit 50k toward the retraction position outside the rotary body 90. The door 14 may be opened in conjunction with this operation or by being pushed by the tray 80.

After the toner cartridge is replaced, the operation of sliding the tray 80k into the rotary body 90 can be performed by driving the motor M2 to rotate in a direction opposite to the rotation direction when sliding the tray 80k to the outside of the rotary body 90. In this case, the tray 80k is pulled to the inside of the rotary body 90 due to the drive racks 15 sliding downward relative to the image forming apparatus 1. Note that “the inside of the rotary body 90” means the position where the toner cartridge 70k is attached to the developing unit 50k. The door 14 may be closed in conjunction with this operation or by being biased by a spring or the like in a closing direction, or may be manually closed.

As mentioned above, the toner cartridge 70 is movable relative to the developing frame 53 between the attachment position and the retraction position where the toner cartridge 70 is retracted from the attachment position. The toner cartridge 70 in the retraction position can be replaced. In the retraction position, the discharge opening 712 of the toner cartridge 70 is open upward relative to the toner cartridge 70. Further, in this state, a receiving opening 532 of the developing unit 50, into which the developer is supplied from the attached toner cartridge 70, is open downward relative to the developing unit 50. By moving into the rotary body 90 the tray 80 on which the toner cartridge 70 in the retraction position is placed, the toner cartridge 70 moves to the attachment position. In this state, the rotary body 90 is driven to rotate to the development position where the developing roller 51 of a target developing unit comes into contact with the photosensitive drum 2 for development.

Note that the aforementioned discharge opening 712 of the first cartridge may be referred to as a first discharge opening, the discharge opening 712 of the second cartridge may be referred to as a second discharge opening, the receiving opening 532 of the first developing unit may be referred to as a first receiving opening, and the receiving opening 532 of the second developing unit may be referred to as a second receiving opening. Furthermore, the orientation of the rotary body 90 in which the direction from the first discharge opening of the first cartridge toward the first receiving opening of the first developing unit has a vertical downward component may be referred to as a first feeding orientation. The orientation of the rotary body 90 in which the first developing member of the first developing unit can develop on the photosensitive drum 2 may be referred to as a first developing orientation.

### Video Controller

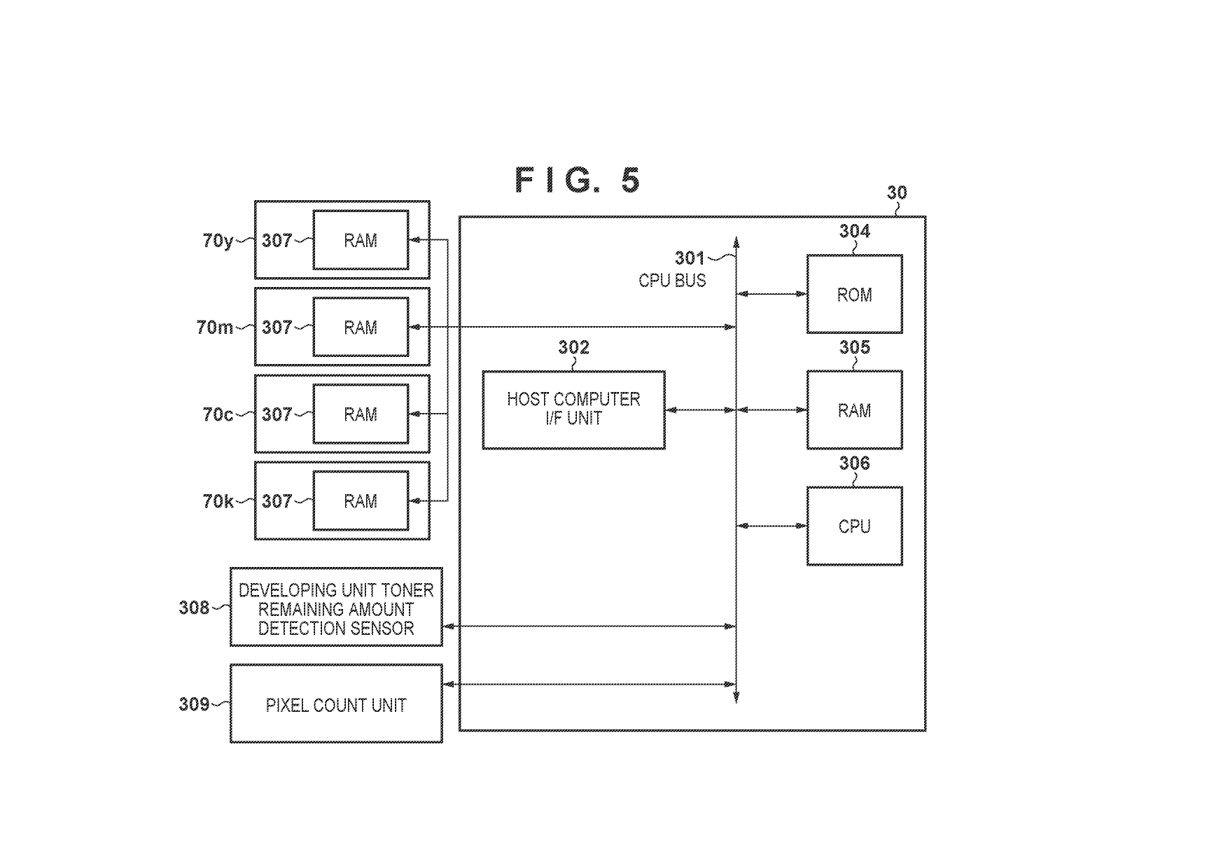

The video controller 30 as an image processing unit will be described with reference to the diagram shown in FIG. 5. The video controller 30 includes various devices such as a host interface unit 302, a ROM 304, a RAM 305, and a CPU 306, which are interconnected via a CPU bus 301. The CPU bus 301 includes address, data, and control buses, and is also connected to a RAM 307, a developing unit toner remaining amount detection sensor 308, and a pixel count unit 309. The host interface unit 302 has a function of bi-directional communication connection with data transmission devices such as a host computer, via a network.

The ROM 304 holds control program code for executing later-described processing. The RAM 305 is a memory for holding a temporary buffer area and various processing statuses. The RAM 305 also stores the remaining amount of toner in the developing unit 50 of each color. The CPU 306 controls each device connected to the CPU bus 301 based on the control program code held in the ROM 304. The RAM 307 is a memory provided in the toner cartridge 70 of each color, and stores the remaining amount of toner or the like in the toner cartridge 70. The developing unit toner remaining amount detection sensor 308 is a sensor that detects whether the remaining amount of toner in the developing unit 50 in the developing orientation is a predetermined amount or more. The pixel count unit 309 counts the number of image dots in developed image data of toner of each color.

Although the video controller 30 and the control unit 151 are separate in this embodiment, either one of them may be configured to serve both functions. In that case, for example, the control unit 151 can detect and manage the remaining amount of toner in the toner cartridge 70 and the developing unit 50.

### Detection of Remaining Amount of Toner

A method of detecting the remaining amount of toner will be described below. The RAM 305 stores the remaining amount of toner in the developing unit 50 of each color. When the developing unit 50 is new, an initial value corresponding to an initial amount of toner in the developing unit 50 is stored. The initial value of the amount of toner in the developing unit 50 is stored in the ROM 304 in advance. Meanwhile, the remaining amount of toner in the toner cartridge 70 of each color is stored in the RAM 307 provided in each of the toner cartridges 70y, 70m, 70c, and 70k. When the toner cartridge 70 is new, an initial value corresponding to the amount of toner in the new toner cartridge 70 is stored.

During image formation, the current remaining amount of toner is obtained by subtracting the amount of toner consumed according to the count of the number of image dots detected by the pixel count unit 309 from the remaining amount of toner in the developing unit 50, and the remaining amount of toner in the developing unit 50 stored in the RAM 305 is updated.

During the rotation operation of the rotary body 90, toner is fed from the toner cartridge 70 to the developing unit 50. When a large amount of toner is remaining in the developing unit 50, the amount of toner that can be fed is low, so that a toner feed amount (the amount of toner to be fed) is determined in accordance with the remaining amount of toner in the developing unit 50. The toner feed amount according to the remaining amount of toner in the developing unit 50 is stored in the ROM 304 as an experimentally determined value in advance. During the rotation operation of the rotary body 90, the current remaining amount of toner is determined by adding this toner feed amount to the remaining amount of toner in the developing unit 50, and the remaining amount of toner in the developing unit 50 stored in the RAM 305 is updated. Along with that, the current remaining amount of toner in the toner cartridge 70 is determined by subtracting the toner feed amount from the remaining amount of toner in the toner cartridge 70, and the remaining amount of toner in the toner cartridge 70 stored in the RAM 307 is updated.

Before the remaining amount of toner in this toner cartridge 70 reaches zero, an indication to that effect is displayed on a liquid crystal panel (not shown) to encourage the user to replace the toner cartridge 70.

Regardless of the remaining amount of toner in the toner cartridge 70, if the remaining amount of toner in the developing unit 50 becomes too low, the developing roller 51 will be driven to rotate with depleted toner, which may cause damage. To prevent this, the developing unit toner remaining amount detection sensor (not shown) is provided. The developing unit toner remaining amount detection sensor is disposed at a position where it can detect that the remaining amount of toner in the developing unit 50 is less than 50%. When detected, an indication to that effect is displayed on the liquid crystal panel (not shown) to encourage the user to replace the toner cartridge 70.

### Image Forming Operation

An image forming operation in this embodiment is now described. Upon receiving image information from an external device (not shown) such as a host computer, the video controller 30 transmits a print signal to start the image forming operation. First, in a standby orientation, the photosensitive drum 2 is rotated in an arrow direction R1 (counterclockwise) in FIG. 1 in synchronization with the rotation of the intermediate transfer belt 10a. Then, the surface of the photosensitive drum 2 is uniformly charged by the charging roller 3.

When forming a color image on the sheet S, the rotary body 90 rotates in an arrow direction R2 in FIG. 1 (clockwise) while supporting the developing units 50y, 50m, 50c, and 50k. An electrophotographic process is then repeated while moving the developing rollers 51y, 51m, 51c, and 51k one by one to the development position.

First, the scanner 4 emits laser light based on image data corresponding to a yellow image, and forms an electrostatic latent image corresponding to the yellow image on the surface of the photosensitive drum 2. In parallel with the formation of this electrostatic latent image, the control unit 151 and the motor M1, which is a DC brush motor (not shown), drive the rotary body 90 to rotate.

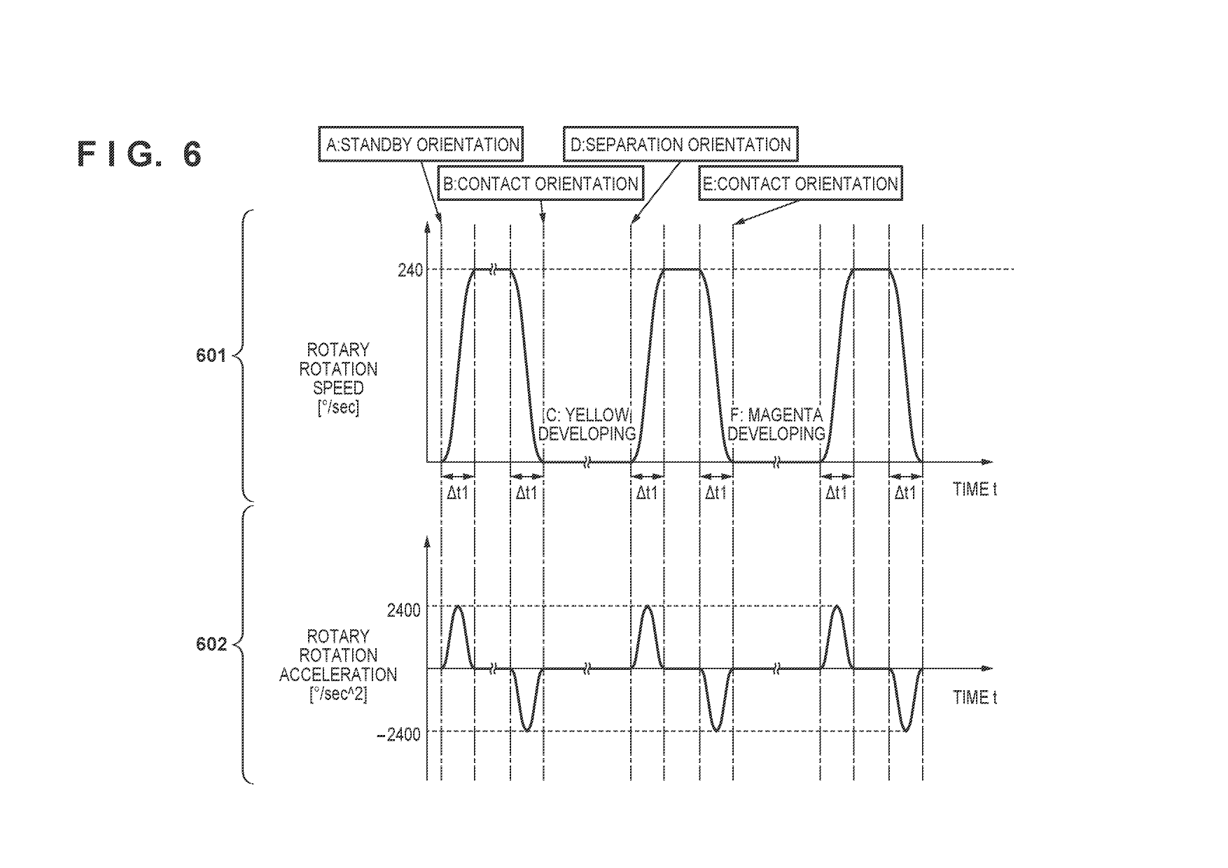

FIG. 6 shows the chronological flow of drive control of the rotary body 90. A diagram 601 shows the rotary rotation speed when the rotary body 90 is subjected to drive control, and a diagram 602 shows the rotary rotation acceleration when the rotary body 90 is subjected to drive control.

First, while the rotary rotates clockwise about the rotation axis 90C to move from the standby orientation shown in FIG. 2C (FIG. 6 - timing A) to the yellow developing orientation, the cam 96 rotates to pivot the rotary body 90 counterclockwise about the pivot shaft 91. This brings the developing roller 51y into contact with the photosensitive drum 2 as shown in FIG. 2A (FIG. 6 - timing B). Note that FIG. 2A shows the case of development with black toner.

The rise of the rotary rotation speed (angular velocity) is controlled to reach a target speed in a predetermined time Δt1 as shown in the diagram 601. Specifically, the rotary rotation speed is raised to 240 degrees/sec in 100 msec. The rotational acceleration (angular acceleration) at that time is as shown in the diagram 602, with a maximum value of 2400 degrees/sec² (indicated as ^{o}/sec^2 in the figure). The reason that the speed is controlled to reach the target speed in a predetermined time is to prevent vibrations caused by the rotation operation of the rotary body 90 from being transmitted to the image forming apparatus 1 through the frame of the rotary body 90 and affecting image forming operations such as charging and exposure. With the developing roller 51y in contact with the photosensitive drum 2, the electrostatic latent image formed on the photosensitive drum 2 is developed with yellow toner (FIG. 6 - period B-C).

Here, in this embodiment, each of the developing rollers 51y, 51m, 51c, and 51k is an elastic roller having a metal shaft covered with rubber. At the development position, each of the developing rollers 51y, 51m, 51c, and 51k develops an electrostatic latent image while in contact with the photosensitive drum 2. That is, the image forming apparatus 1 in the present embodiment employs a contact developing method.

After the yellow toner image is developed, the yellow toner image on the photosensitive drum 2 is primarily transferred to the intermediate transfer belt 10a shown in FIG. 1 by the primary transfer roller 11 located inside the intermediate transfer belt 10a.

After the electrostatic latent image formed on the photosensitive drum 2 is developed with the yellow toner, the cam 96 rotates again to separate the developing roller 51y from the photosensitive drum 2 by pivoting the rotary body 90 in the clockwise direction about the pivot shaft 91. By rotating the rotary body 90 clockwise about the rotation axis 90C in this state, the developing unit 50m begins to move to the magenta developing orientation (FIG. 6 - timing D). The rise and fall of the rotary rotation speed at this time is also controlled to reach the target speed in the predetermined time Δt1.

In this embodiment, the rotary body 90 does not rotate during the contact/separation operation between the developing roller 51 and the photosensitive drum 2. However, to reduce the image forming time, the contact/separation operation between the developing roller 51 and the photosensitive drum 2 may also be performed while the rotary body 90 rotates. Note that, in this case, the rotary speed needs to rise and fall more slowly than usual in order to prevent vibrations caused by the contact and separation between the developing roller 51 and the photosensitive drum 2 from affecting the image forming operations such as charging and exposure.

In this manner, the rotary body 90 is rotated by 90 degrees each time to move the developing rollers 51m, 51c, and 51k to the development position in order, thereby forming toner images of the respective colors. That is, after the yellow toner image is formed on the intermediate transfer belt 10a, the rotary body 90 assumes a magenta developing orientation (FIG. 6 - timing E), and a magenta toner image is formed on the intermediate transfer belt 10a. Similarly, after a magenta toner image is formed on the intermediate transfer belt 10a, the rotary body 90 assumes a cyan developing orientation, and a cyan toner image is formed on the intermediate transfer belt 10a. After the cyan toner image is formed on the intermediate transfer belt 10a, the rotary body 90 assumes a black developing orientation, and the black toner image is formed on the intermediate transfer belt 10a. When color images are formed successively, the rotary body 90 again assumes the yellow developing orientation after a black toner image is formed on the intermediate transfer belt 10a, and sequentially develops each color. When color images are not successively formed, the rotary body 90 returns to the standby orientation.

Then, a color image is formed on the intermediate transfer belt 10a by repeating primary transfer so as to overlap four-color toner images on the intermediate transfer belt 10a. Note that the secondary transfer roller 12 and the cleaning device 13 are not in contact with the intermediate transfer belt 10a before a color image is formed on the intermediate transfer belt 10a. After the color image is formed on the intermediate transfer belt 10a, the secondary transfer roller 12 and the cleaning device 13 come into contact with the intermediate transfer belt 10a to prepare for secondary transfer. Meanwhile, the sheet S is fed from the sheet containing section 300 located in the lower part of the image forming apparatus 1 by the pick-up roller 310. The sheet S is fed to the transport roller pair 320 in a state separated from other sheets S one by one by the feed roller 311 and the separation roller 312. The transport roller pair 320 sends the fed sheet S to a transfer section (secondary transfer section), which is a nipped part between the intermediate transfer belt 10a and the secondary transfer roller 12. The color image on the intermediate transfer belt 10a is transferred (secondary transfer) to the surface of the transported sheet S.

The sheet S with the color image transferred is sent to the fixing device 40. In the fixing device 40, the sheet S is heated and pressed, and the image is fixed onto the sheet S. The sheet S that has passed through the fixing device 40 is discharged as a product to the outside of the image forming apparatus 1.

When forming a black monochrome image on the sheet S, the rotary body 90 is rotated to shift from the standby orientation to the black developing orientation. After an electrostatic latent image is formed in this state on the surface of the photosensitive drum 2 by charging and exposing the photosensitive drum 2, the electrostatic latent image is developed with black toner by the developing roller 51k in the developing position. When successively forming black monochrome images, development is continued in the black developing orientation. When black monochrome images are not successively formed, the rotary body 90 returns to the standby orientation. The black toner image is to primary transferred onto the intermediate transfer belt 10a and then secondary transferred onto the sheet S. The subsequent process is the same as for color images.

### Toner Feeding Operation

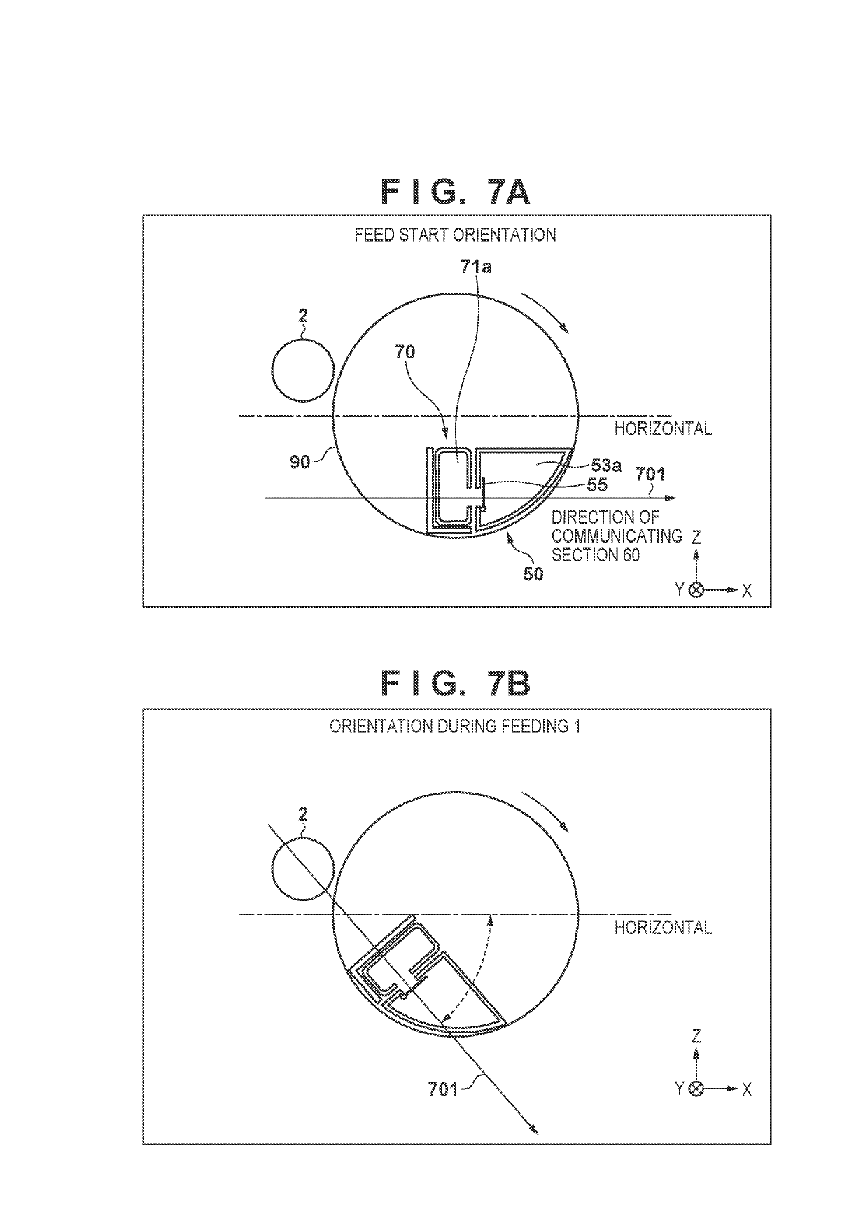

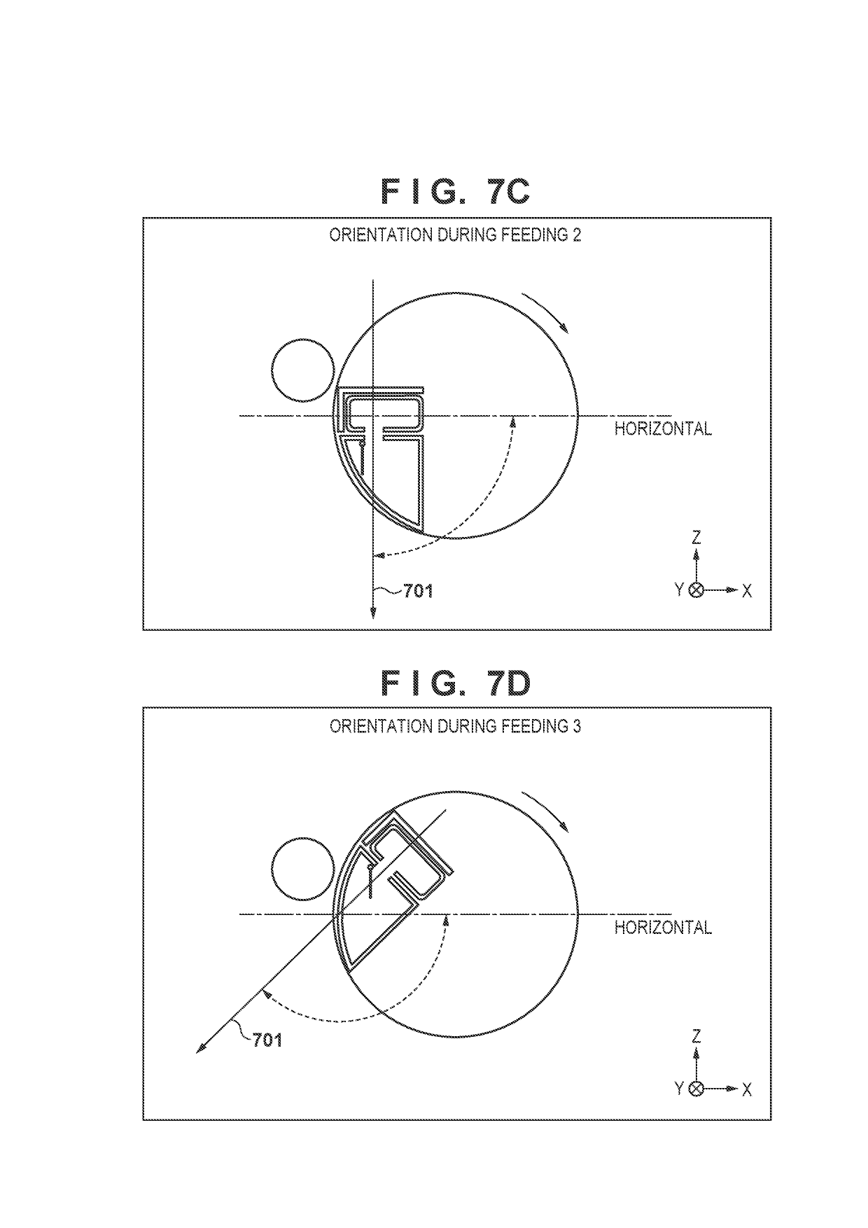

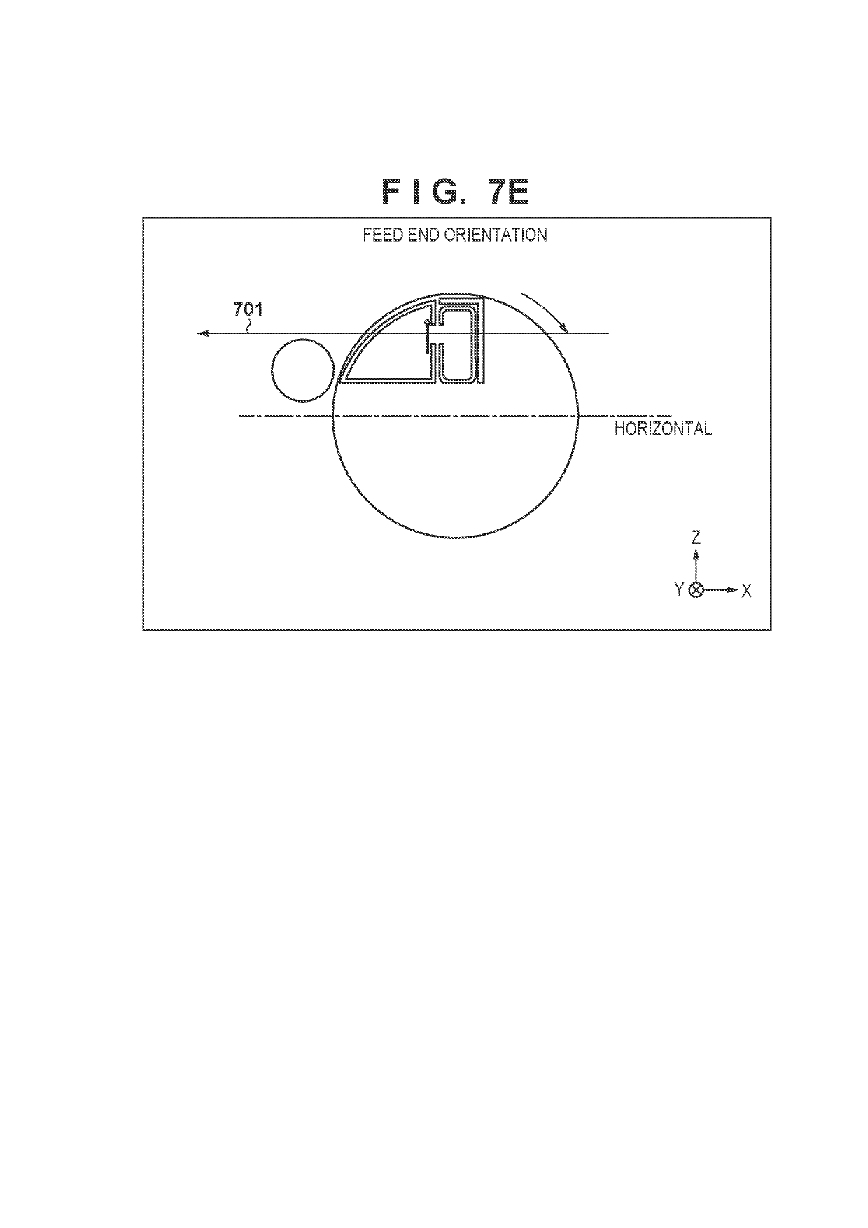

The operation of feeding toner from the toner cartridge 70 to the developing unit 50 according to this embodiment will be described with reference to FIGS. 7A to 7E. FIGS. 7A to 7E illustrate the orientations for feeding toner from the toner cartridge 70 to the developing unit 50. The orientation of the rotary body 90 in which toner is fed from the toner cartridge 70 to the developing unit 50 when the rotary body 90 is rotated once is referred to as a “feeding orientation”.

The toner contained in the toner containing section 71a of the toner cartridge 70 is discharged through the discharge opening 71b and fed into the developing-side containing section 53a through the receiving opening 53b. Since the toner is fed as a result of its movement due to gravity, the feeding orientation is such that the communicating section 60 formed by the discharge opening 71b of the feeding target toner cartridge 70 and the receiving opening 53b of the developing unit 50 is directed downward in the vertical direction relative to the horizontal. The direction of the communicating section 60 refers to the direction of the communicating section 60 as viewed from the toner containing section 71a side, and is indicated by arrow 701 in FIGS. 7A to 7E. For example, the yellow feeding orientation in this embodiment starts from an orientation in which the communicating section 60 is rotated even slightly in the clockwise direction from the horizontal orientation shown in FIG. 7A. The feeding orientation is in the range from this orientation at the start through the orientation in which the communicating section 60 is directed downward in the vertical direction relative to the horizontal, as shown in FIGS. 7B, 7C, and 7D, to immediately before the communicating section 60 is directed horizontally again, as shown in FIG. 7E. In contrast, in the orientation where the communicating section 60 formed by the discharge opening 71b of the toner cartridge 70 and the receiving opening 53b of the developing unit 50 is directed horizontally or upward in the vertical direction relative to the horizontal, the communicating section 60 is blocked by the sealing member 55. This prevents the toner from flowing back from the developing unit 50 to the toner cartridge 70.

In this feeding orientation, the toner contained in the toner containing section 71a is discharged through the discharge opening 71b, and the toner discharged from the discharge opening 71b is fed into the developing-side containing section 53a through the receiving opening 53b. The toner contained in the developing-side containing section 53a is supplied to the developing roller 51. The toner contained in the toner containing section 71a is supplied to the developing roller 51 through the above-described route.

### Toner Supply Failure and Resolution Sequence

However, if the toner cartridge 70 is left unused for a long period of time, there are cases where the toner contained in the toner containing section 71a adheres to wall surfaces, or particles of the toner adhere to each other, making it difficult to feed the toner into the developing-side containing section 53a. Particularly in a hot and humid environment, the toner in the toner containing section 71a is more likely to adhere. Adhered toner is not supplied to the developing-side containing section 53a and remains in the toner containing section 71a. The toner cartridge is replaced with a new one while the residual toner is unused, resulting in wasted toner.

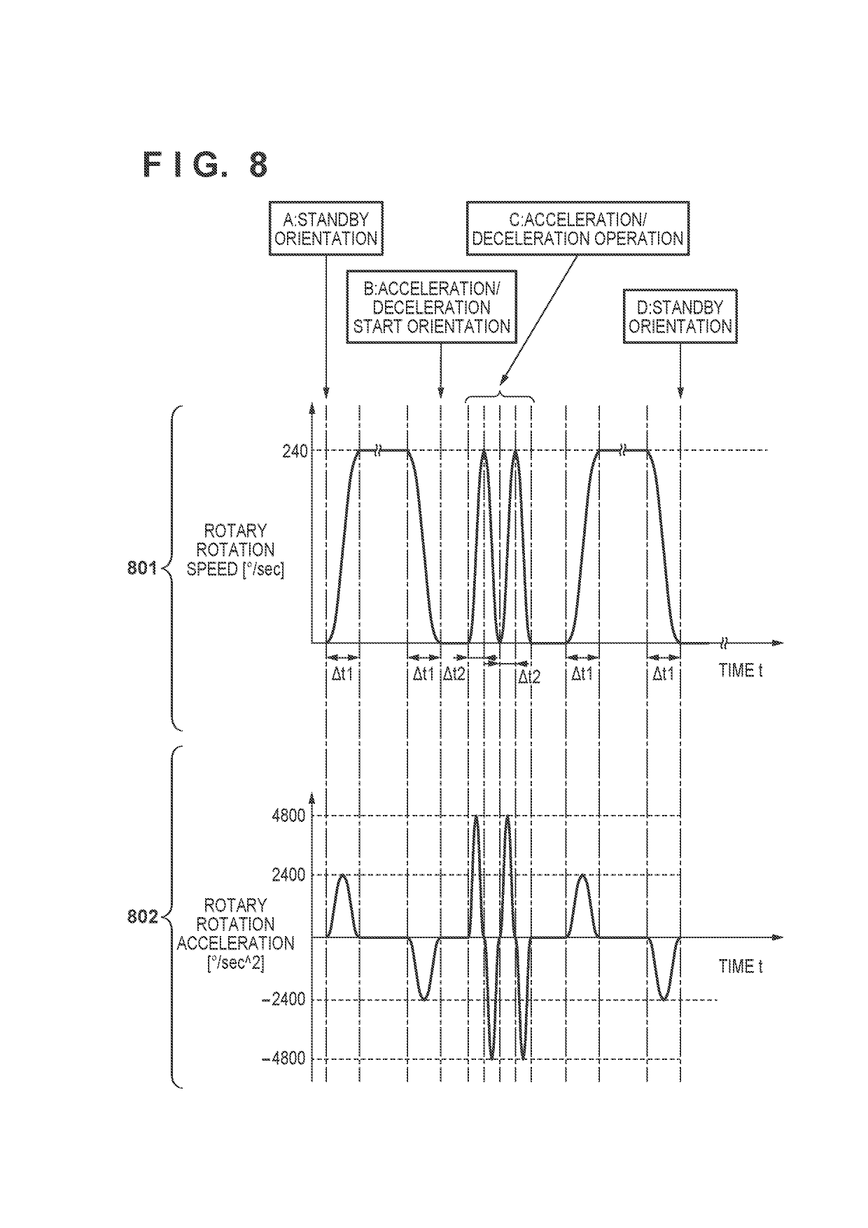

Therefore, in this embodiment, a rotary operation mode is implemented for the purpose of loosening adhered toner in the toner containing section 71a. This operation mode will be described with reference to FIGS. 8 and 9A to 9D. FIG. 8 shows the chronological flow of the drive control of the rotary body 90 in the case of loosening adhered toner in the yellow toner cartridge 70y. A diagram 801 shows the rotary rotation speed when the rotary body 90 is subjected to drive control, and a diagram 802 shows the rotary rotation acceleration when the rotary body 90 is subjected to drive control. FIGS. 9A to 9D show the orientations of the yellow toner cartridge 70y during each drive control.

From the standby orientation shown in FIG. 9A (FIG. 8 - timing A), the rotary body 90 is rotated by 90 degrees clockwise. This causes the rotary body 90 to assume an acceleration/deceleration operation start orientation, as shown in FIG. 9B (FIG. 8 - timing B). In the acceleration/deceleration operation start orientation, the communicating section 60 formed by the discharge opening 71b of the yellow toner cartridge 70y and the receiving opening 53b of the developing unit 50y (indicated by arrow 901) is directed downward in the vertical direction relative to the horizontal.

Next, an acceleration/deceleration operation is performed to drive (i.e., accelerate) the rotary body 90 in a time Δt2 shorter than the rising time Δt1 of the rotary body 90 during image formation shown in FIG. 6 and immediately bring it to a quick stop (i.e., decelerate) (FIG. 8 - period C). The time Δt2 in this embodiment is 50 msec, and the maximum value of acceleration at that time is 4800 degrees/sec². Since image formation is not in progress while this operation mode is implemented, the rotary body 90 can be quickly driven or stopped. This acceleration/deceleration operation rises the rotary rotation in the time Δt2 shorter than the rising time Δt1 of the rotation speed of the rotary body 90 during image formation, and stops in the same time Δt2 in deceleration. Therefore, particularly focusing on the maximum absolute value of acceleration, the acceleration during this acceleration/deceleration operation shown in the diagram 802 is larger than the acceleration of the rotation during image forming operation shown in the diagram 602.

This acceleration/deceleration operation applies an inertial force to the adhered toner in the toner containing section 71a, thereby loosening toner clumps. The toner adhered to walls A and B of the toner containing section 71a in FIG. 9B is then subjected to the inertial force and either falls directly into the developing-side containing section 53a or falls into the developing-side containing section 53a along the slope of a wall C, and is fed thereto. This acceleration/deceleration operation causes the rotary body 90 to rotate by about 20 degrees clockwise in FIGS. 9A to 9D. By performing this operation two times, the rotary body 90 rotates by a total of about 40 degrees to reach the orientation shown in FIG. 9C. Note that the number of times the acceleration/deceleration operation is performed is not limited to two times, and it may be performed at least two times. This operation loosens adhered toner, including not only the toner adhered to the walls A and B of the toner containing section 71a in FIG. 9B, but also toner adhered to a wall D of the toner containing section 71a in FIG. 9D. After this operation ends, the rotary body 90 is rotated clockwise and returned to the standby orientation again (FIG. 8 - timing D).

In FIG. 8 in this embodiment, the acceleration/deceleration operation is performed two times, but the number of times is not limited thereto. It is also effective to perform this operation once, and the effect increases as the number of times increases. FIG. 9D shows the orientation when the acceleration/deceleration operation shown in the period C in FIG. 8 is further performed from the state in FIG. 9C and is then completed. The rotary body 90 in FIG. 9D is further rotated by 40 degrees clockwise from FIG. 9C, during which the third acceleration/deceleration operation can be performed. As mentioned above, the fourth acceleration/deceleration operation can also be performed. A higher toner loosening effect can be achieved by repeating the acceleration/deceleration two or more times, i.e., multiple times.

The above rotary acceleration/deceleration operation mode is implemented immediately before the user replaces the toner cartridge 70, or when the amount of toner in the toner containing section 71a of the toner cartridge becomes small, or when the amount of toner in the developing-side containing section 53a becomes small. “Immediately before the user replaces the toner cartridge 70” may refer to, for example, when the user performs an operation for replacing the toner cartridge 70, i.e., an operation for moving the toner cartridge of a desired color to the retraction position. This operation allows the control unit 151 to ascertain that the user is about to replace the toner cartridge 70. Further, the remaining amount of toner in the toner cartridge 70 is calculated using the amount of consumed toner corresponding to the count of the number of image dots detected by the pixel count unit 309 and stored in the RAM 307, as mentioned above. After each image formation ends, the remaining amount of toner in the toner cartridge 70 stored in the RAM 307 is read, and the above operation mode is executed after image formation before the remaining amount of toner becomes zero. Also, even when the remaining amount of toner in the toner cartridge 70 stored in the RAM 307 is sufficient, the above operation mode is executed when the developing unit toner remaining amount detection sensor 308 detects that the remaining amount of toner in the developing unit 50 falls below a certain threshold. “Falling below a threshold” may be rephrased as “becoming smaller than the threshold”. Even if the remaining amount of toner in the toner cartridge 70 is sufficient, there is a possibility that the toner adheres to the walls or the like of the toner containing section 71a, the toner is not supplied to the developing-side containing section 53a of the developing unit 50, and the amount of toner in the developing-side containing section 53a becomes small. When the amount of toner in the developing-side containing section 53a becomes small, members such as the developing roller 51 may be damaged. To prevent this, the above operation mode is executed when the developing unit toner remaining amount detection sensor 308 detects that the remaining amount of toner in the developing unit 50 falls below a certain threshold, thereby loosening the toner in the toner cartridge 70 so that the toner can be fed to the developing-side containing section 53a.

Further, the above operation mode may also be executed when the remaining amount of toner in the toner cartridge 70 is large or when the remaining amount of toner in the developing unit 50 is large. For example, the above operation mode may be executed when the image forming apparatus has not been used for a long period of time, or when the user gives an instruction. The number of rotary rotations increases by executing the above operation mode. However, by performing the rotary acceleration/deceleration operation in a state where there is toner that has not yet adhered in the toner cartridge 70, the toner that has not adhered collides with adhered toner, thereby increasing the toner loosening effect.

The present embodiment has been described by taking as an example the rotary acceleration/deceleration operation mode for the yellow cartridge 70y. Not limited thereto, the same effects can also be achieved in the other toner cartridges, namely the magenta cartridge 70m, cyan cartridge 70c, and black cartridge 70k, by performing the rotary acceleration/deceleration operation in the toner feeding orientation described in the present embodiment.

As described above, a failure in supplying the toner from the toner cartridge 70 to the developing unit 50 can be suppressed by implementing the rotary operation mode in the present embodiment to loosen toner clumps adhered in the toner containing section 71a of the toner cartridge 70. This allows the toner in the toner cartridge to be used more efficiently than before.

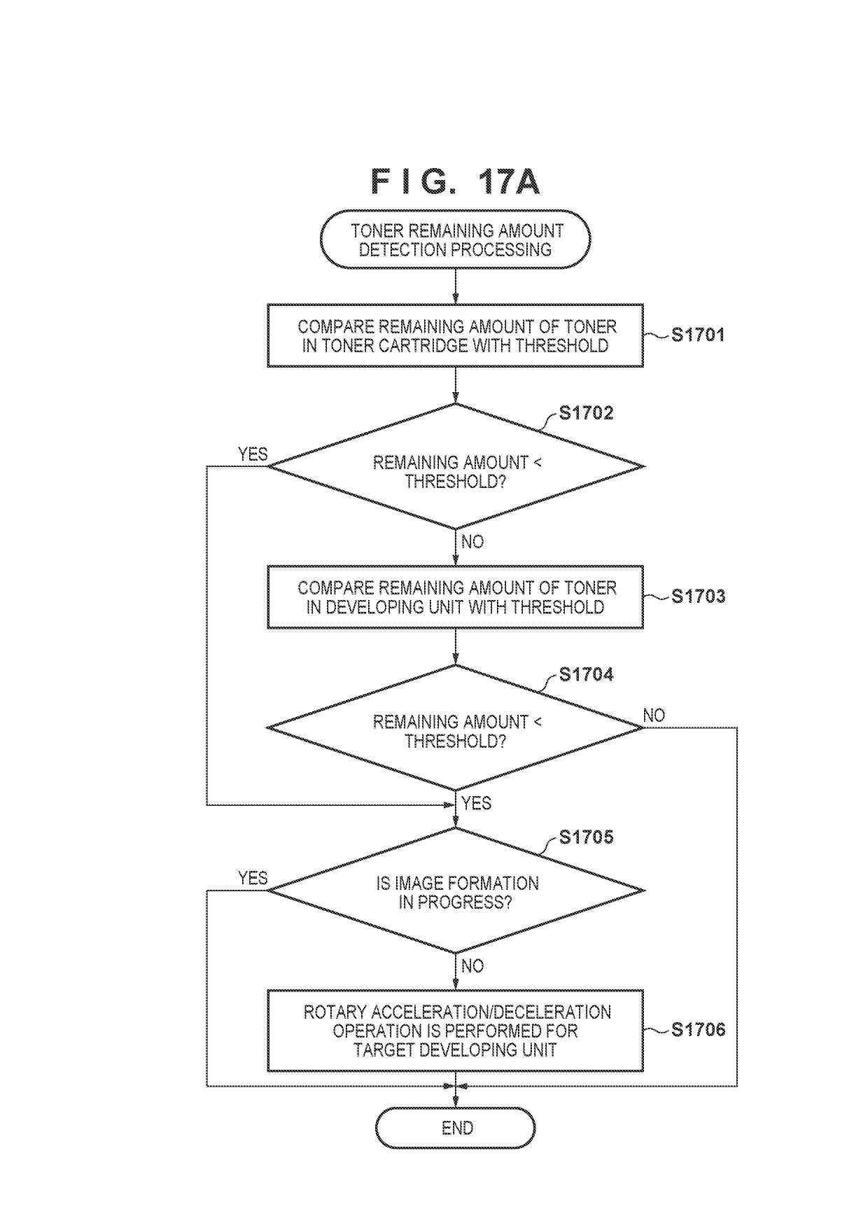

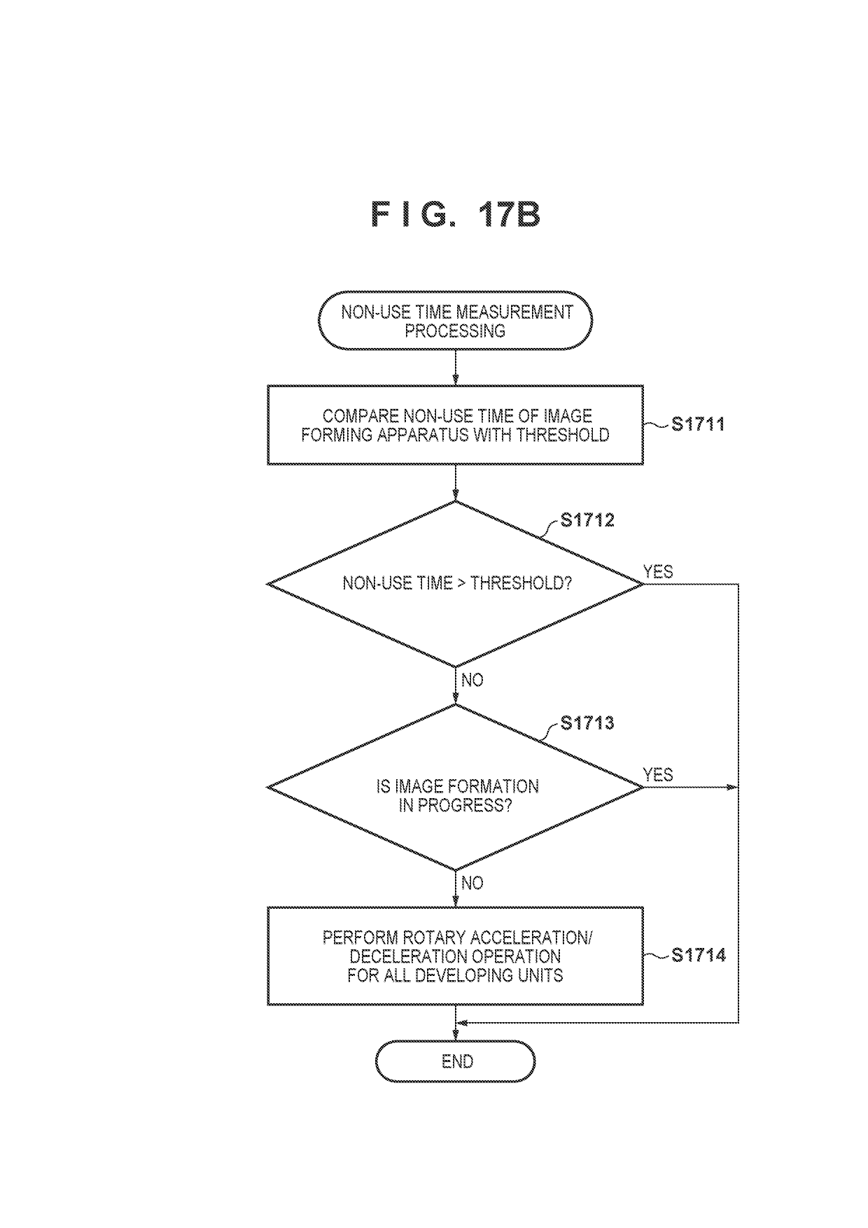

FIGS. 17A and 17B show examples of control procedures when the control unit 151 performs the toner loosening operation and the rotary acceleration/deceleration operation. FIG. 17A shows processing when the acceleration/deceleration operation is performed in response to the remaining amount of toner becoming smaller than the threshold. FIG. 17B shows an example in which the acceleration/deceleration operation is performed in response to the image forming apparatus 1 not being used for a period longer than a time serving as a threshold. Both the procedures in FIGS. 17A and 17B are realized by the CPU 1511 of the control unit 151 executing a program read from the memory 1512. The toner remaining amount detection processing and non-use time measurement processing shown in FIGS. 17A and 17B may be performed, for example, periodically. Note that the frequency of the non-use time measurement processing may be lower than the frequency of the toner remaining amount detection processing. The procedures in FIGS. 17A and 17B are more effective when the toner cartridge 70 is attached. Thus, it may be determined whether all toner cartridges 70 are attached prior to the processing in FIGS. 17A and 17B. If not all cartridges are attached, a configuration may be employed in which processing is not performed or a message or the like encouraging the user to attach the toner cartridges 70 is output.

When the toner remaining amount detection processing is executed in FIG. 17A, the control unit 151 first compares the remaining amount of toner in the toner cartridge 70 with a threshold (S1701). Note that, in the above description, the video controller 30 manages the remaining amount of toner in the toner cartridge 70 and the developing unit 50, and the thresholds. The control unit 151 may obtain these values from the video controller 30 to perform the control shown in FIGS. 17A and 17B. Alternatively, the control unit 151 may manage the remaining amount of toner and hold the thresholds in place of the video controller 30.

If the control unit 151 determines that the remaining amount of toner in the toner cartridge 70 is smaller than the threshold, the processing branches to S1705 (S1702 - Yes) and determines whether the image forming operation is in progress (S1705). If the control unit 151 determines that the image forming operation is not in progress, the rotary acceleration/deceleration operation is performed as illustrated in FIG. 8 (S1706). At this time, the control unit 151 particularly controls the motor M1, which is a driving source, to perform this operation. In S1706, the rotary acceleration/deceleration operation may be performed targeting the developing unit or the toner cartridge for which the remaining amount of toner is determined to be smaller than the threshold. In this case, the phase of the rotary body 90 may be adjusted such that the target developing unit 50 comes to the position of the yellow developing unit 50y in the standby orientation shown in FIG. 9A, and the rotary acceleration/deceleration operation may be performed from that state.

On the other hand, if the control unit 151 determines that the remaining amount of toner in the toner cartridge 70 is greater than or equal to the threshold, the control unit 151 compares the remaining amount of toner in the developing unit 50 with a threshold (S1704). If the control unit 151 determines that the remaining amount of toner in the developing unit 50 is smaller than the threshold, the processing branches to S1705. If the control unit 151 then determines that the image forming operation is not in progress, the rotary acceleration/deceleration operation is performed as illustrated in FIG. 8 (S1706). If the control unit 151 determines that the remaining amount of toner in the toner cartridge 70 is greater than or equal to the threshold and the remaining amount of toner in the developing unit 50 is greater than or equal to the threshold, the processing ends. Note that the threshold in S1701 and the threshold in S1712 may be different values, and may also be referred to as a first threshold and a second threshold, respectively.

When the non-use time measurement processing in FIG. 17B is executed, the control unit 151 first compares the non-use time of the image forming apparatus 1 with a threshold (S1711). Regarding the non-use time, for example, the time of use may be stored each time the image forming apparatus 1 is used, and the elapsed time from the latest stored time to the current time may be obtained and used as the non-use time. Of course, this is an example, and the non-use time may be obtained by any other method. If the control unit 151 determines that the non-use time is longer than the threshold, the processing branches to S1713 (S1712 - YES). If the control unit 151 then determines that the image forming operation is not in progress (S1713 - NO), the rotary acceleration/deceleration operation is performed as illustrated in FIG. 8 (S1714). On the other hand, if the control unit 151 determines that the non-use time is less than or equal to the threshold, the processing ends. Here, in S1714, unlike S1706, the rotary acceleration/deceleration operation is performed for all the developing units. This is because the toner that needs to be loosened is not limited to the toner of a specific color. Note that, even if the rotary acceleration/deceleration operation is repeated two times, the rotation angle, i.e., the phase of the rotary advances only 40 degrees, as already described. Thus, the rotary acceleration/deceleration operation can be completed for the developing units of all colors while the rotary body 90 rotates once.

The rotary acceleration/deceleration processing can be performed with the above procedures based on the remaining amount of toner or the non-use time. In addition, S1705 may also be executed to perform the rotary acceleration/deceleration operation when, for example, the user has performed an operation for replacing the toner cartridge or given an instruction to perform the rotary acceleration/deceleration operation, as mentioned above.

Although the yellow developing unit 50y and the toner cartridge 70y have been described as examples in the present embodiment, the same may apply to the developing units 50 and the toner cartridge 70 of the other colors. The positions of the developing units 50 and the toner cartridges 70 other than those of yellow in the standby position are different from the positions shown in FIG. 9A, but the effect of loosening toner can be obtained by the acceleration/deceleration operation of the rotary body 90. However, the direction of the communicating section is not always downward along a vertical line. To improve the effect of supplying toner from the toner cartridge 70 to the developing unit 50, the developing unit and the toner cartridge of each color are moved to the positions of the yellow developing unit 50y and toner cartridge 70y in the standby orientation shown in FIG. 9A. Then, the rotary may be accelerated or decelerated with those positions as references.

Also, the determination in S1705 may also be performed immediately before S1701 and immediately before S1711, and the processing may be terminated if image formation is in progress.

### Embodiment 2

In Embodiment 1, the rotary acceleration/deceleration operation is performed only in the orientation in which the direction of the communicating section 60, which is formed by the receiving opening 53b of the developing unit 50y and the discharge opening 71b of the target toner cartridge in which adhered toner is to be loosened, is downward in the vertical direction relative to the horizontal.

In the present embodiment, the rotary acceleration/deceleration operation is also performed in orientations other than the aforementioned orientation, thereby loosening more toner adhered to all wall surfaces of the toner containing section 71a, collecting the toner, and then efficiently supplying the toner to the developing-side containing section 53a of the developing unit 50. The overall configuration and image forming operation of the image forming apparatus except for the rotation control in the rotary operation mode are the same as those of Embodiment 1, and the description thereof is omitted. Further, the timing of performing the rotary operation mode of the present embodiment is also the same as that of Embodiment 1, and the description thereof is omitted.

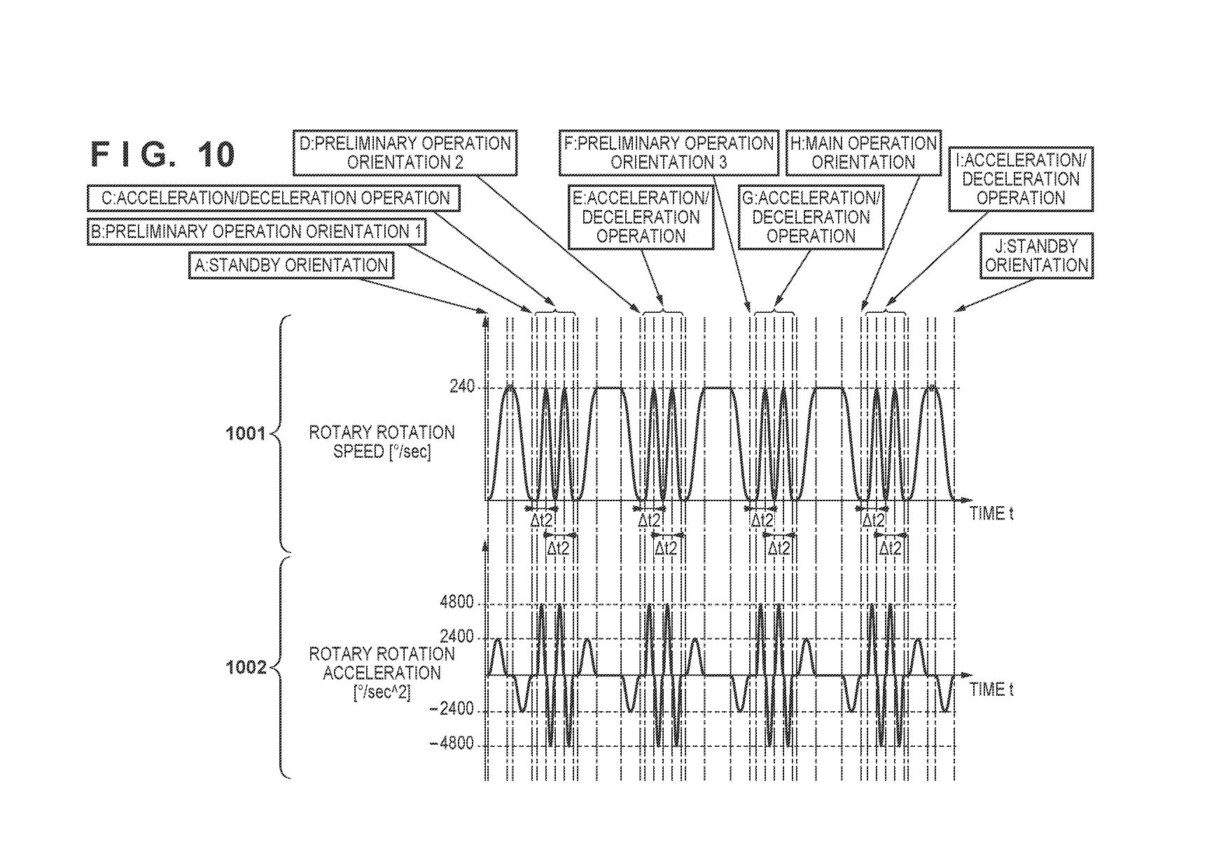

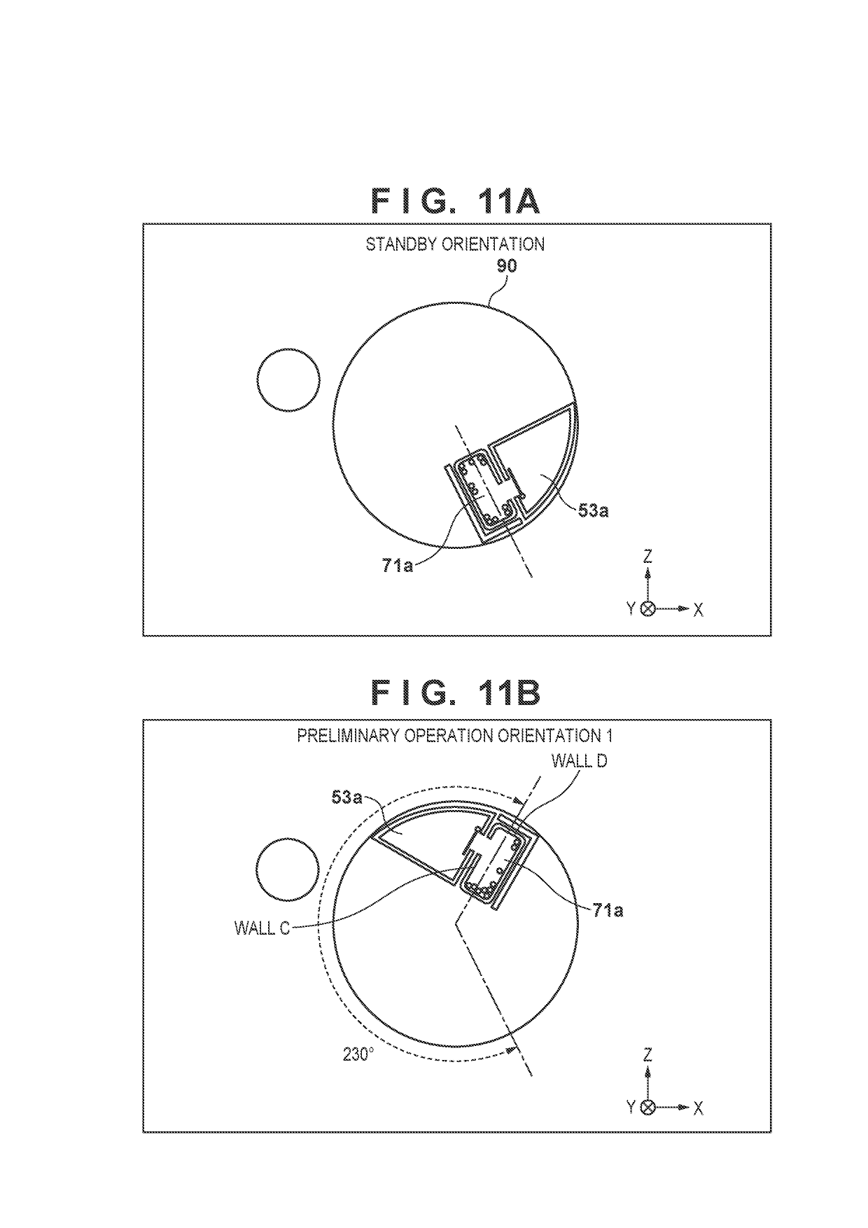

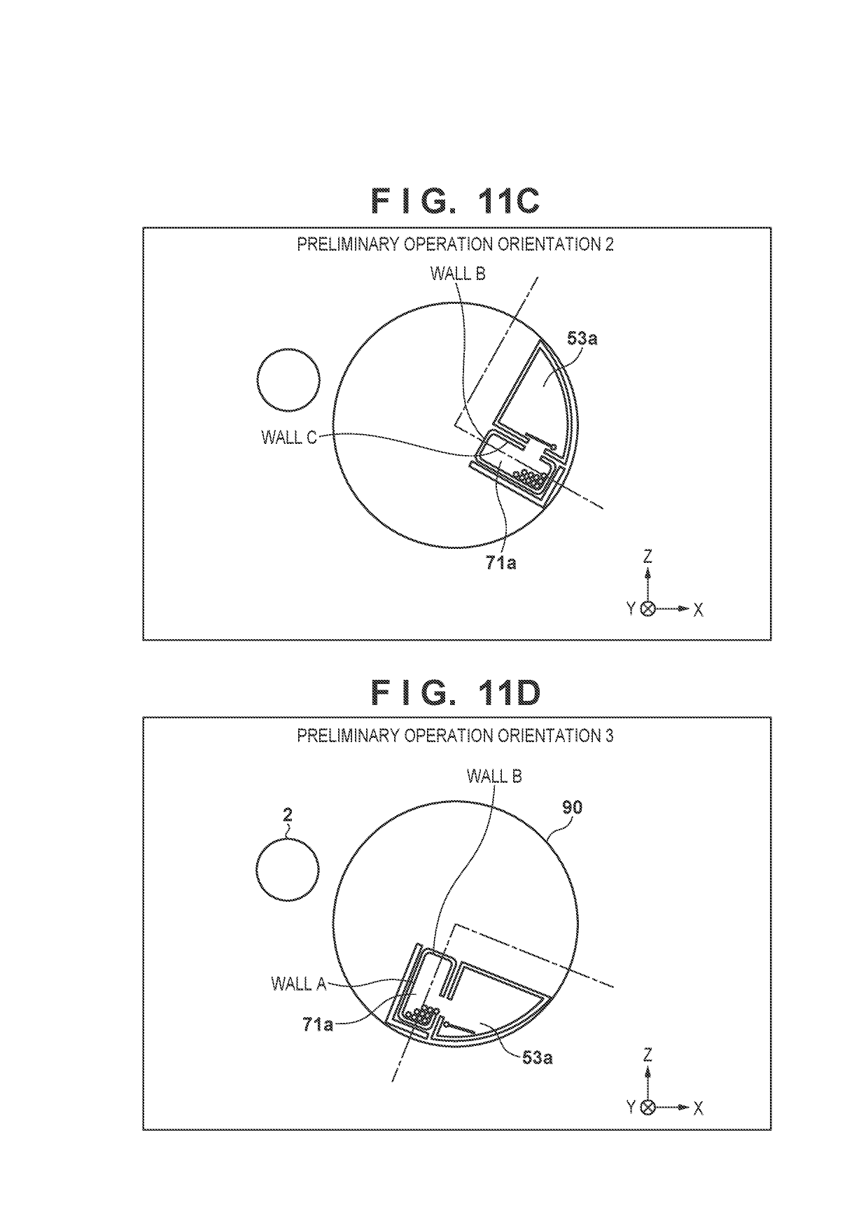

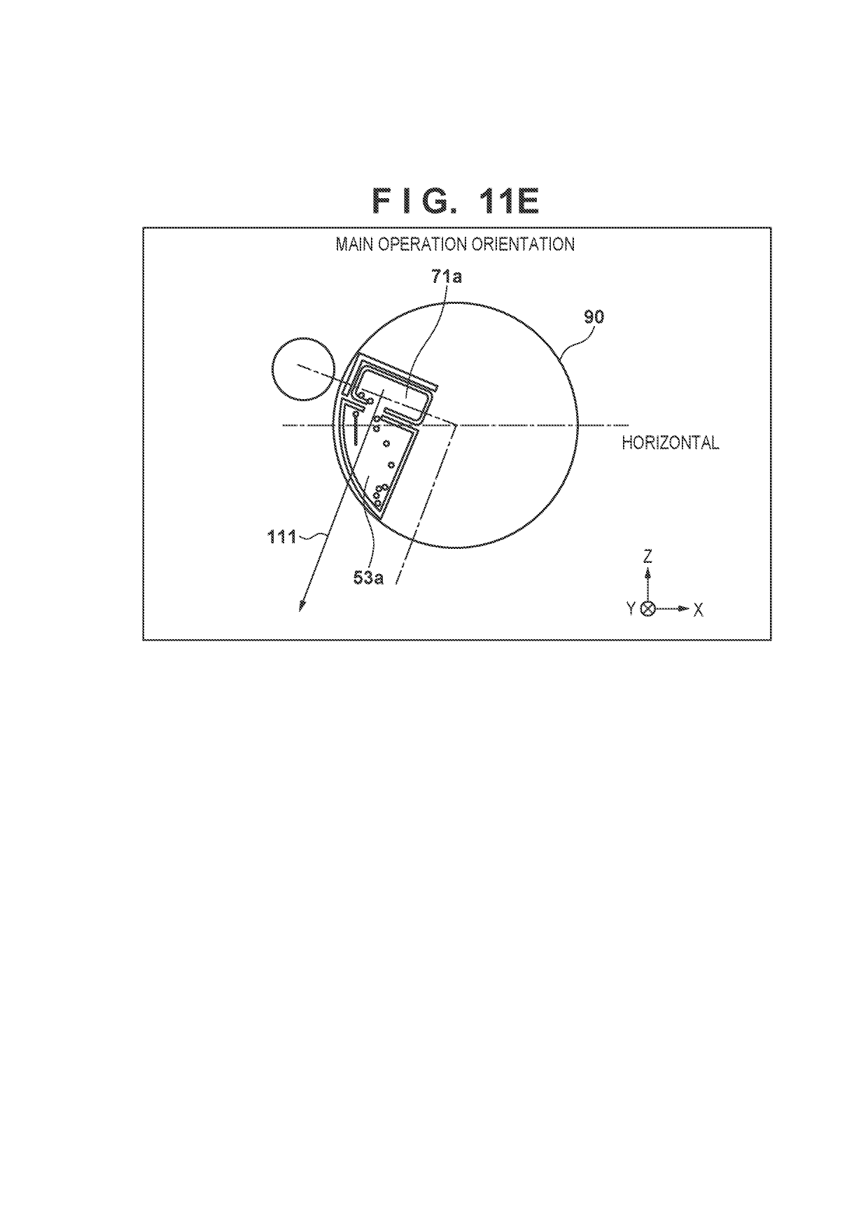

The rotary operation mode in which toner is fed from the toner cartridge 70 to the developing unit 50 according to the present embodiment will be described with reference to FIGS. 10 and 11A to 11E. FIG. 10 shows the chronological flow of drive control of the rotary body 90 when loosening adhered toner in the yellow toner cartridge 70y. A diagram 1001 shows the rotary rotation speed when the rotary body 90 is subjected to drive control, and a diagram 1002 shows the rotary rotation acceleration when the rotary body 90 is subjected to drive control. FIGS. 11A to 11E show the orientations of the yellow toner cartridge 70y during each drive control. In the rotary operation mode of the present embodiment, a preliminary operation for loosening and collecting adhered toner and a main operation of feeding the toner to the developing-side containing section 53a are performed.

### Preliminary Operation

From a standby orientation shown in FIG. 11A (FIG. 10 - timing A), the rotary body 90 is rotated clockwise by 230 degrees and moved to a preliminary operation orientation 1 shown in FIG. 11B (FIG. 10 - timing B). The preliminary operation orientation 1 is an orientation in which the toner adhered to the walls C and D of the toner containing section 71a is separated from the walls by gravity and falls. Next, an acceleration/deceleration operation is performed to drive the rotary body 90 in the time Δt2 shorter than the rising time Δt1 of the rotation speed of the rotary body 90 during image formation shown in FIG. 6, and immediately bring it to a quick stop (FIG. 10 - period C). The time Δt2 in the present embodiment is 50 msec, and the maximum value of the acceleration at that time is 4800 degrees/sec². Since image formation is not in progress during this operation mode, the rotary body 90 can be quickly driven or stopped. In this acceleration/deceleration operation, the rotation of the rotary rises in the time Δt2 shorter than the rising time Δt1 of the rotation speed of the rotary body 90 during image formation. Thus, the acceleration in the rotation of the acceleration/deceleration operation shown in the diagram 1002 is greater than or equal to the acceleration in the rotation during image formation shown in the diagram 602. In this operation, the rotary rotates by about 20 degrees clockwise, so that it rotates by a total of about 40 degrees as a result of performing this operation two times. This acceleration/deceleration operation applies an inertial force to adhered toner in the toner containing section 71a, thereby loosening toner clumps, and the toner adhered to the walls C and D of the toner containing section 71a in FIG. 11B is accumulated at the lowermost part of the toner containing section 71a in the preliminary operation orientation 1 by gravity.

Next, the rotary body 90 is rotated clockwise by about 50 degrees and moved to a preliminary operation orientation 2 shown in FIG. 11C (FIG. 10 - timing D). The preliminary operation orientation 2 is an orientation in which the toner adhered to the walls B and C of the toner containing section 71a is separated from the walls by gravity and falls. The acceleration/deceleration operation is performed again in the preliminary operation orientation 2 (FIG. 10 - period E). This acceleration/deceleration operation applies an inertial force to the adhered toner in the toner containing section 71a, thereby loosening toner clumps, and the toner adhered to the walls B and C of the toner containing section 71a in FIG. 11C is accumulated at the lowermost part of the toner containing section 71a in the preliminary operation orientation 2 by gravity.

Further, the rotary body 90 is rotated clockwise by about 50 degrees and moved to a preliminary operation orientation 3 shown in FIG. 11D (FIG. 10 - timing F). The preliminary operation orientation 3 is an orientation in which the toner adhered to the walls A and B of the toner containing section 71a is separated from the walls by gravity and falls. The acceleration/deceleration operation is performed again in the preliminary operation orientation 3 (FIG. 10 - period G). This acceleration/deceleration operation applies an inertial force to the adhered toner in the toner containing section 71a, thereby loosening toner clumps, and the toner adhered to the walls A and B of the toner containing section 71a in FIG. 11D is accumulated at the lowermost part of the toner containing section 71a in the preliminary operation orientation 3 by gravity. The acceleration/deceleration operation as the preliminary operation so far achieves a state where the toner adhered to all the walls of the toner containing section 71a, including the toner adhered to the wall C that is not sufficiently loosened in Embodiment 1, is loosened by the inertial force and collected to the lowermost part of the toner containing section 71a in the preliminary operation orientation 3.

### Main Operation

With all the toner collected at the lowermost part of the toner containing section 71a as a result of the acceleration/deceleration operation in the preliminary operation, the rotary body 90 is rotated clockwise by about 50 degrees and moved to a main operation orientation shown in FIG. 11E (FIG. 10 - timing H). This operation orientation is an orientation in which the direction of the communicating section 60, which is formed by the discharge opening 71b of the toner cartridge 70y and the receiving opening 53b of the developing unit 50y, is downward in the vertical direction relative to the horizontal. The collected toner can be effectively fed to the developing-side containing section 53a by performing the acceleration/deceleration operation here again (FIG. 10 - period I). After this operation ends, the rotary is rotated clockwise and returned to the standby orientation again (FIG. 10 - timing J).

As described above, in the present embodiment, not only the main operation is performed in a first phase, but also the preliminary operation is performed in a second phase, which is 90 degrees earlier than the first phase. In the present embodiment, the initial preliminary operation is performed at a phase 270 degrees earlier than the first phase, and thereafter the preliminary operation is performed three times in total at each phase advanced by 90 degrees. Accordingly, in the present embodiment, the “second phase” includes a plurality of phases that are shifted, or earlier, by 90 degrees from the first phase. Not limited to this, the effect of supplying toner to the developing unit 50 can be increased if the preliminary operation is performed at least once prior to the main operation.

Note that the operation of accelerating and decelerating the rotary is performed within a certain range of rotation angle of the rotary (20 degrees for one acceleration and deceleration in the above example), so that the first phase can be regarded as a phase in which the operation starts, and it can also be said that the acceleration and deceleration is performed within a predetermined phase range.

Also, in the case where three preliminary operations and the main operation are performed targeting yellow as in the present embodiment, three preliminary operations and one main operation are also performed for the developing units 50 of the other colors, although the order is different. Therefore, one main operation can be performed after three preliminary operations for each of the development units 50 of all colors by performing two sets of loosening operations, each of which involves performing three preliminary operations and one main operation while rotating the rotary body 90 by 90 degrees each time.

In the present embodiment, two acceleration/deceleration operations are performed as a set, but the number of times is not limited thereto. It is also effective to perform the acceleration/deceleration operation once, and the effect increases as the number of times increases.

The present embodiment has been described by taking as an example the rotary acceleration/deceleration operation mode for the yellow cartridge 70y. However, the same effect can also be achieved with the other cartridges, namely the magenta cartridge 70m, the cyan cartridge 70c, and the black cartridge 70k.

### Embodiment 3

In Embodiments 1 and 2, the rotary acceleration/deceleration operation is performed by rotating the rotary body 90 in a rotation direction R2 during image formation. In the case where the rotary rotates forward only, the motor cost can be reduced by employing a simple configuration of a motor driver circuit to make it perform forward rotation only. However, if the rotary rotates forward only, the rotary phase advances each time the acceleration/deceleration operation is performed, and the acceleration/deceleration operation at an aimed phase cannot be repeatedly performed in a short time. In the present embodiment, the effect of loosening adhered toner is increased by performing the acceleration/deceleration operation in both the rotary rotation direction R2 and the reverse rotation direction. By performing the rotary acceleration/deceleration operation in both directions alternately, more adhered toner in the toner containing section 71a can be loosened at an aimed rotary phase without advancing the rotary phase and without limiting the number of times, thus making it possible to efficiently feed the toner to the developing-side containing section 53a. Further, the reverse rotation operation of the rotary body 90 is not performed during normal image forming operations. Thus, a force that is not applied during normal image formation is applied to the rotary body 90 by performing the rotary operation mode of the present embodiment, and the adhered toner can be loosened effectively. The overall configuration and image forming operation of the image forming apparatus except for the rotation control in the rotary operation mode are the same as those of Embodiment 1, and the description thereof is omitted. Also, the rotary operation mode of the present embodiment is rotation control in which the same preliminary operation and main operation as in Embodiment 2 are performed except for the acceleration/deceleration operation, and the description thereof is omitted. Further, the timing of performing the rotary operation mode of the present embodiment is also the same as that of Embodiment 1, and the description thereof is omitted.

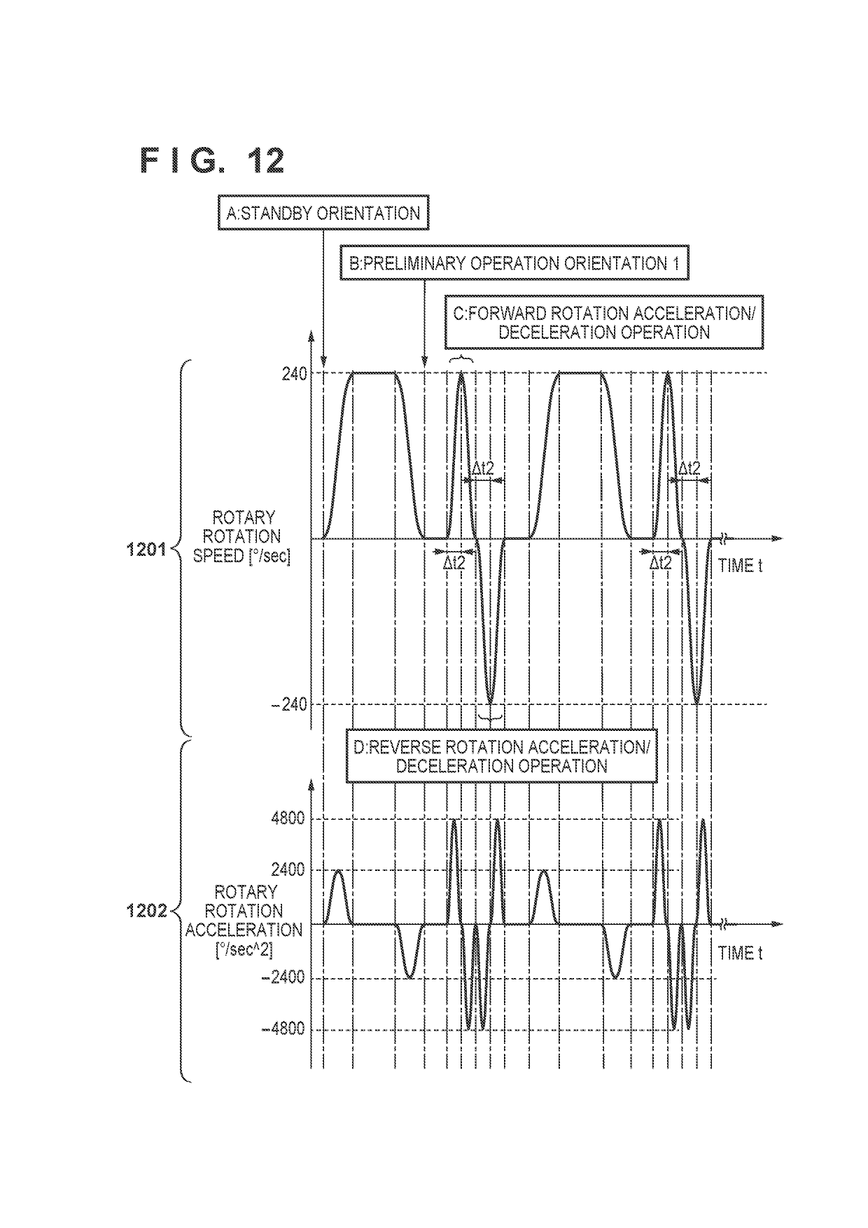

The acceleration/deceleration operation in the rotary operation mode in which toner is fed from the toner cartridge 70 to the developing unit 50 according to the present embodiment will be described with reference to FIG. 12. FIG. 12 shows the chronological flow of drive control of the rotary body 90 when loosening adhered toner in the yellow toner cartridge 70y according to the present embodiment. A diagram 1201 shows the rotary rotation speed when the rotary body 90 is subjected to drive control, and a diagram 1202 shows the rotary rotation acceleration when the rotary body 90 is subjected to drive control.

In the present embodiment, the acceleration/deceleration operation is performed in both the rotary rotation direction R2 (forward rotation direction) shown in FIG. 1 and the reverse rotation direction, as mentioned above. After moving from the standby orientation shown in FIG. 11A (FIG. 12 - timing A) to the preliminary operation orientation 1 in FIG. 11B (FIG. 12 - timing B), the acceleration/deceleration operation is performed to drive the rotary body 90 in the direction R2 in the rising time Δt2 and immediately bring it to a quick stop (FIG. 12 - period C). The time Δt2 in the present embodiment is 50 msec, and the maximum value of the acceleration at that time is 4800 degrees/sec². Next, the acceleration/deceleration operation is performed to drive the rotary body 90 in the time Δt2 similarly in the direction reverse to the direction R2 (reverse rotation direction), and immediately bring it to a quick stop (FIG. 12 - period C). These forward rotation operation and reverse rotation operation cause the rotary phase to return to the preliminary operation orientation 1, which is the original orientation. This acceleration/deceleration operation applies an inertial force to the adhered toner in the toner containing section 71a, thereby loosening toner clumps, and the toner adhered to the walls C and D of the toner containing section 71a in FIG. 11B is accumulated at the lowermost part of the toner containing section 71a in the preliminary operation orientation 1 by gravity.

Similarly, the acceleration/deceleration operation is performed in the direction R2 (forward rotation direction) and the direction reverse to the direction R2 (reverse rotation direction) at high speed in the preliminary operation orientations 2 and 3 shown in FIGS. 11C and 11D. As a result, all the toner adhered to the walls of the toner containing section 71a enters a state of being collected at the lowermost part of the toner containing section 71a in the preliminary operation orientation 3. The preliminary operation orientation 2 is an orientation in which the rotary body 90 is rotated by about 90 degrees after the rotary acceleration/deceleration operation is performed in the preliminary operation orientation 1. Similarly, the preliminary operation orientation 3 is an orientation in which the rotary body 90 is rotated by about 90 degrees after the rotary acceleration/deceleration operation is performed in the preliminary operation orientation 2.

Lastly, the acceleration/deceleration operation is also performed in the direction R2 (forward rotation direction) and the direction reverse to the direction R2 (reverse rotation direction) at high speed similarly in the main operation orientation shown in FIG. 11E. This operation allows the toner that has been separated or loosened and collected from the walls to be effectively fed to the developing-side containing section 53a.

In the present embodiment, the acceleration/deceleration operation is performed once in each of the direction R2 (forward rotation direction) and the direction reverse to the direction R2 (reverse rotation direction) at high speed in one preliminary operation orientation or the main operation orientation. However, the number of times is not limited thereto, and the effect increases as the number of times increases. Further, in the present embodiment, the acceleration/deceleration operation can be performed without changing the rotary phase, so that the acceleration/deceleration operation at the most effective rotary phase can be repeated in a short time. The present embodiment has been described by taking as an example the rotary acceleration/deceleration operation mode for the yellow cartridge 70y. However, the same effect can also be achieved with the other cartridges, namely the magenta cartridge 70m, the cyan cartridge 70c, and the black cartridge 70k.

### Embodiment 4

In Embodiments 1 to 3, adhered toner in the toner containing section 71a of the toner cartridge 70 is loosened by performing rotation control on the rotary body 90 to apply a force to the adhered toner. In contrast, in the present embodiment, the effect of loosening adhered toner is further increased by applying a force thereto from outside the rotary body 90.

Specifically, the cam 96 shown in FIGS. 2A and 2D is rotated at a speed higher than during normal image formation and repeatedly made to collide with the frame of the rotary body 90, thereby imparting vibration to the entire rotary body 90 to loosen the adhered toner. That is, the cam 96 functions as a vibration unit. The overall configuration and image forming operation of the image forming apparatus except for the cam 96 and the rotary rotation control are the same as those of Embodiment 1, and the description thereof is omitted. Also, the timing of performing the rotary operation mode of the present embodiment is also the same as that of Embodiment 1, and the description thereof is omitted.

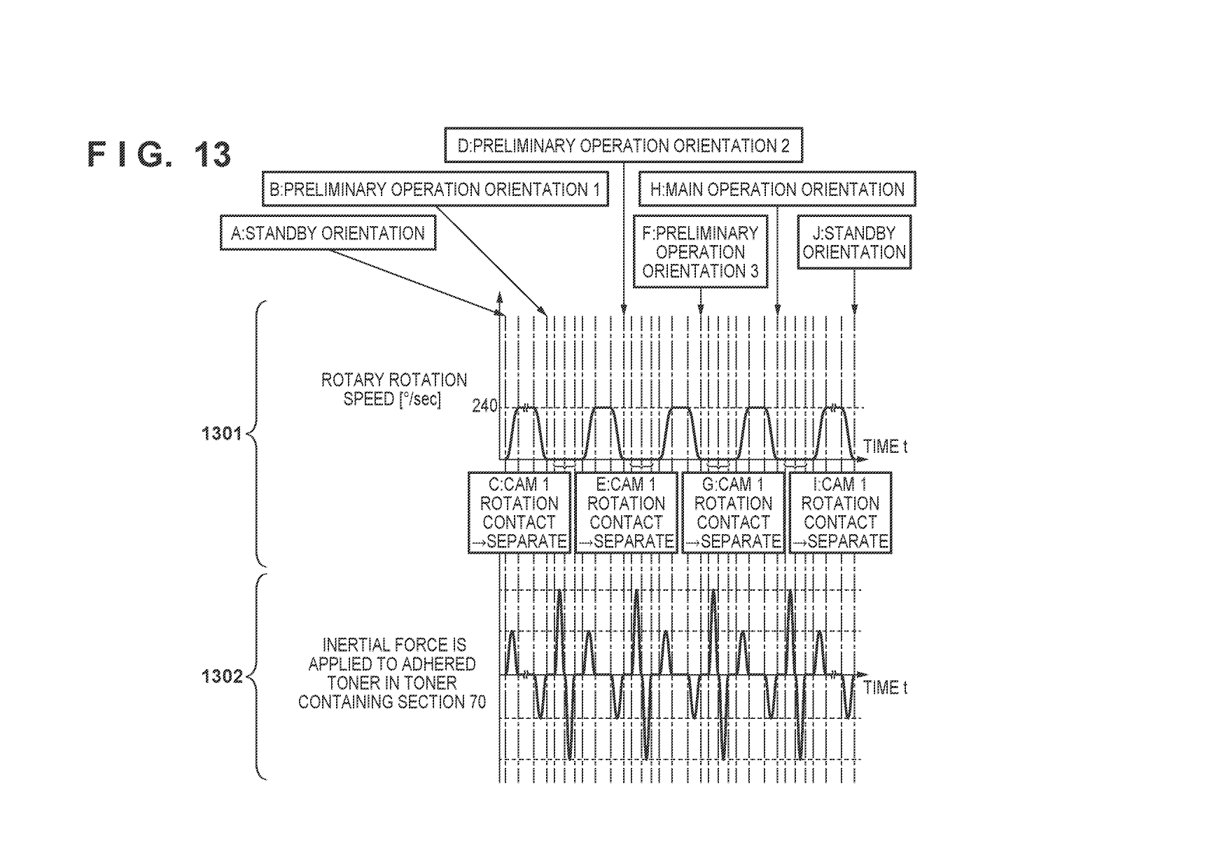

FIG. 13 shows the chronological flow of drive control of the rotary body 90 when loosening adhered toner in the yellow toner cartridge 70y. A diagram 1301 shows the rotary rotation speed when the rotary body 90 is subjected to drive control, and a diagram 1302 shows the inertial force applied to the adhered toner in the toner containing section 71a. The basic operation of the rotary is the same as that of Embodiment 2, while in the present embodiment, instead of the acceleration/deceleration operation of the rotary body 90, the cam 96 is rotated and made to collide with the frame of the rotary body 90, thereby imparting vibration thereto. Here, the driving source for rotating the cam 96 may be one of the motors M shown in FIG. 15, for example. The rotation of the cam 96 is thus controlled by the control unit 151. First, after the rotary body 90 moves from the standby orientation shown in FIG. 11A (FIG. 13 - timing A) to the preliminary operation orientation 1 shown in FIG. 11B (FIG. 13 - timing B), the cam 96 is rotated once at high speed to impart vibration to the frame of the rotary body 90 (FIG. 13 - period C). In the preliminary operation orientation 1, the developing roller 51y and the photosensitive drum 2 are at positions not facing each other. Thus, the photosensitive drum 2 and the developing roller 51y do not come into contact with each other even if the cam 96 is rotated, and vibration can be imparted to the rotary body 90. When the cam 96 is thus brought into contact with and separated from the frame of the rotary body 90 at high speed, the rotary body 90 vibrates about the pivot shaft 91. Thus, an inertial force having a vector different from the inertial force obtained at the rotation axis 90C of the rotary body 90 can be applied to the adhered toner in the toner containing section 71a.

As a result of the cam 96 thus rotating to impart vibration, the inertial force is applied to the adhered toner in the toner containing section 71a, thereby loosening toner clumps. Then, the toner adhered to the walls C and D of the toner containing section 71a in FIG. 11B is accumulated at the lowermost part of the toner containing section 71a in the preliminary operation orientation 1 by gravity.

In the preliminary operation orientations 2 and 3 shown in FIGS. 11C and 11D, similarly, the cam 96 is rotated two times at high speed to impart vibration to the frame of the rotary body 90 (FIG. 13 - periods E and G), thereby loosening the toner in the toner containing section 71a. The loosened toner eventually enters a state of being collected at the lowermost part of the toner containing section 71a in the preliminary operation orientation 3.

Lastly, in the main operation orientation, the cam 96 is similarly rotated once at high speed to impart vibration to the frame of the rotary body 90 (FIG. 13 - period I). The thus-collected toner can be effectively fed to the developing-side containing section 53a.

In the present embodiment, the cam 96 rotates once in one preliminary operation orientation and the main operation orientation, but the number of times is not limited thereto. The effect increases as the number of times increases. Further, in the present embodiment, only the cam 96, which is located outside the rotary body 90, is rotated. Therefore, the vibration can be imparted in a shorter time than by rotating the rotary body 90, thereby allowing toner to be loosened more effectively.

The present embodiment has been described by taking as an example the rotary acceleration/deceleration operation mode for the yellow cartridge 70y. However, the same effect can also be achieved with the other cartridges, namely the magenta cartridge 70m, the cyan cartridge 70c, and the black cartridge 70k.

### Variation

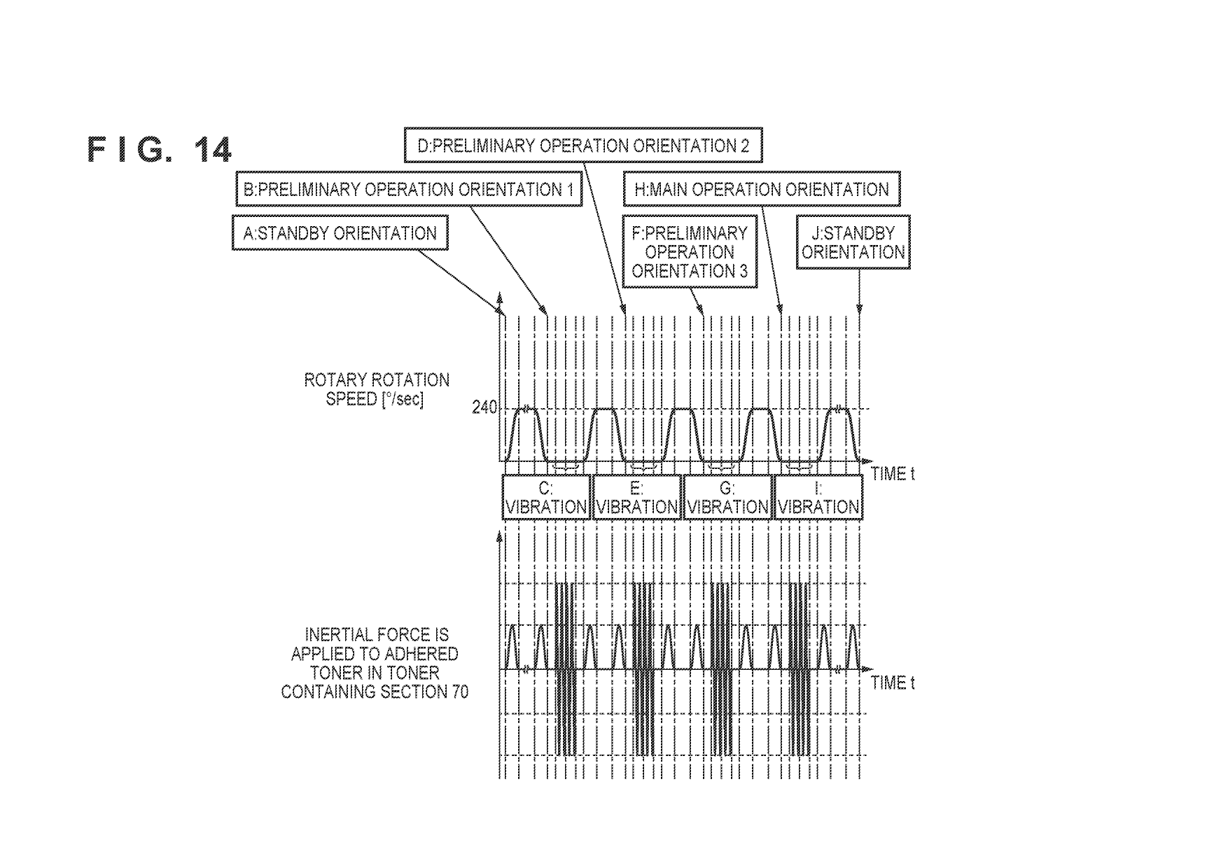

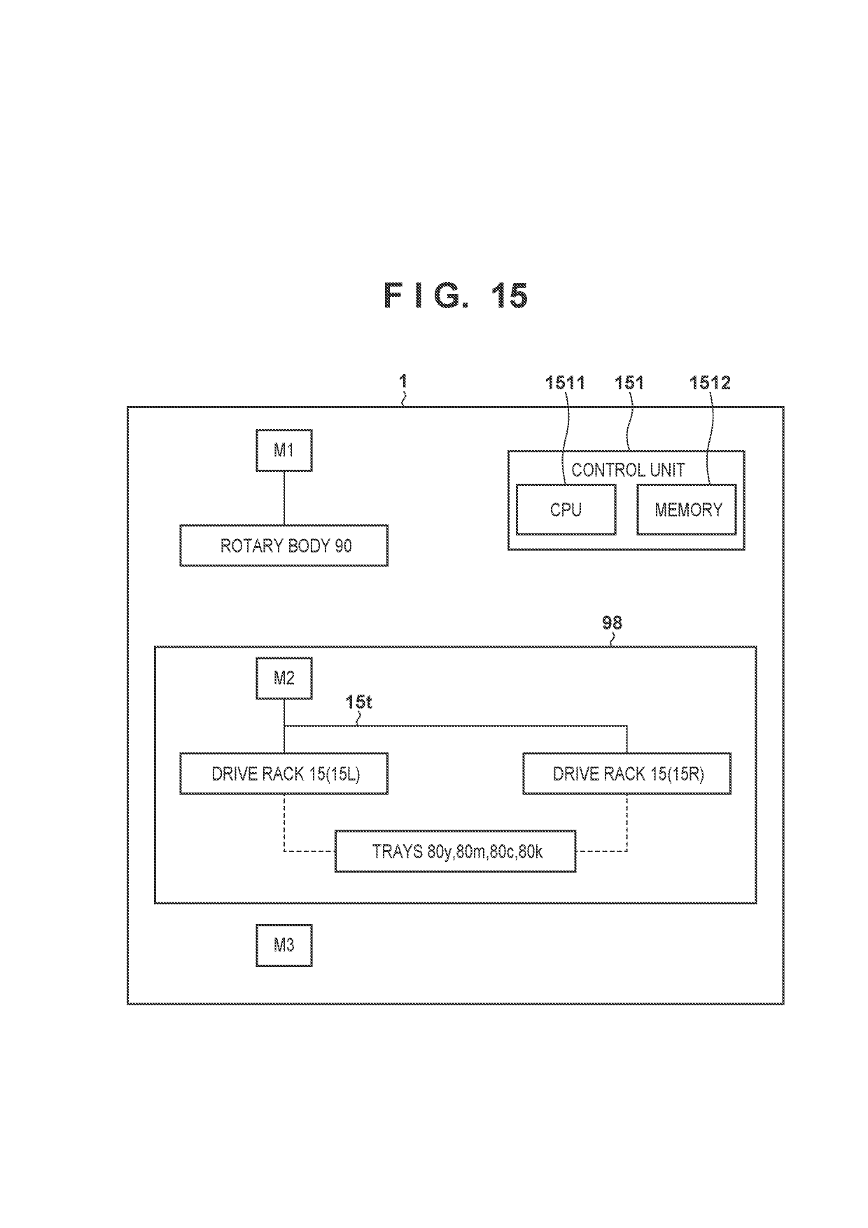

In this variation, the effect of loosening adhered toner is increased by applying a force from outside the rotary body 90. In the above description, the cam 96, which is located outside the rotary body 90, imparts vibration, but a vibration actuator may alternatively be used as a means for imparting vibration from the outside. Vibration can be imparted to the entire rotary body 90 to loosen the adhered toner by bringing the vibration actuator, which is installed outside the rotary body 90 such that it can come into contact with and move away from the rotary body 90, into contact with the frame at a certain rotary phase. Further, this variation does not involve rotation operations of the rotary body 90 and the cam 96, and can therefore be implemented in a silent state with less operation noise. As shown in FIG. 14, the vibration imparted to the rotary body 90 is synchronized with the changes in the phase of the rotary body 90. Therefore, in this variation, the vibration actuator (not shown) is also controlled by the control unit 151.

FIG. 14 shows the chronological flow of the rotary body 90 when loosening adhered toner in the yellow toner cartridge 70y.

First, after the rotary body 90 moves from the standby orientation shown in FIG. 11A (FIG. 14 - timing A) to the preliminary operation orientation 1 shown in FIG. 11B (FIG. 14 - timing B), the vibration actuator is operated to impart vibration to the frame of the rotary body 90 (FIG. 14 - period C). In this variation, a rotary actuator of an eccentric rotating mass type that utilizes rotation is used as the vibration actuator to impart vibration to the rotary body 90. As a result of the vibration actuator thus imparting vibration to the rotary body 90, an inertial force is applied to the adhered toner in the toner containing section 71a, thereby loosening toner clumps. Then, the toner adhered to the walls C and D of the toner containing section 71a in FIG. 11B is accumulated at the lowermost part of the toner containing section 71a in the preliminary operation orientation 1 by gravity. In the preliminary operation orientations 2 and 3 shown in FIGS. 11C and 11D, similarly, the vibration actuator is operated to impart vibration to the frame of the rotary body 90 (FIG. 14 - periods E and G), thereby loosening the toner in the toner containing section 71a. The loosened toner eventually enters a state of being collected at the lowermost part of the toner containing section 71a in the preliminary operation orientation 3.

Lastly, in the main operation orientation, the vibration actuator is similarly operated to impart vibration to the frame of the rotary body 90 (FIG. 14 - period I). The thus-collected toner can be effectively fed to the developing-side containing section 53a. After the main operation ends, the vibration actuator is again separated from the frame of the rotary body 90, and the rotary body 90 is rotated and moved to the standby orientation (FIG. 14 - timing J).

In this variation, a rotary actuator (eccentric rotating mass type) that utilizes rotation is used as the vibration actuator to impart vibration to the rotary body 90. However, it is also possible to use a piezoelectric actuator that utilizes the piezoelectric effect, or an electromagnetic actuator that utilizes a coil. Although the vibration actuator is used to impart vibration to the entire rotary in this variation, a configuration may alternatively be employed in which a member is caused to collide with the frame of the rotary body 90 to apply impact thereto. This variation has been described by taking as an example the rotary acceleration/deceleration operation mode for the yellow cartridge 70y. However, the same effect can also be achieved with the other cartridges, namely the magenta cartridge 70m, the cyan cartridge 70c, and the black cartridge 70k.

### Other Embodiments

Embodiment(s) of the present invention can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-070816, filed April 24, 2024, which is hereby incorporated by reference herein in its entirety.

What is claimed is:

1. An image forming apparatus to and from which a first cartridge containing a first developer and a second cartridge containing a second developer are attachable and detachable, the image forming apparatus comprising:
a first developing unit including:
a first container for containing the first developer supplied from the first cartridge; and
a first developing member configured to develop an electrostatic latent image formed on a photosensitive member using the first developer contained in the first container;
a second developing unit including:
a second container for containing the second developer supplied from the second cartridge; and
a second developing member configured to develop the electrostatic latent image formed on the photosensitive member using the second developer contained in the second container;
a rotatable rotary including the first developing unit and the second developing unit;
a drive mechanism configured to drive the rotary to rotate the rotary; and
a controller configured to control the drive mechanism,
wherein the first developer in the first cartridge is supplied to the first container by being discharged from a first discharge opening formed in the first cartridge to a first receiving opening formed in the first container,
the rotary is configured to assume:
a first feeding orientation in which a direction from the first discharge opening to the first receiving opening has a vertical downward component; and
a first developing orientation in which the first developing member is capable of developing the electrostatic latent image on the photosensitive member,
the controller comprises:
at least one memory storing instructions; and
at least one processor that is in communication with the at least one memory and that, when executing the instructions, cooperates with the at least one memory to execute processing, and
the processing includes controlling the drive mechanism to perform at least two times an acceleration/deceleration operation in which the rotary accelerates and thereafter decelerates, during a period in which the rotary rotates from the first feeding orientation to the first developing orientation.

2. The image forming apparatus according to claim 1,
wherein the rotation of the rotary is repeatedly accelerated and decelerated, alternately in a first rotation direction and a second rotation direction different from the first rotation direction.

3. The image forming apparatus according to claim 1,
wherein the acceleration and the deceleration of the rotation of the rotary are started in the first feeding orientation.

4. The image forming apparatus according to claim 3,
wherein the acceleration and the deceleration of the rotation of the rotary are started in a second feeding orientation different from the first feeding orientation before being started in the first feeding orientation.

5. The image forming apparatus according to claim 4,
wherein the second feeding orientation includes a plurality of orientations obtained by rotating the rotary by 90 degrees each time from the first feeding orientation.

6. The image forming apparatus according to claim 1,
wherein an absolute value of the acceleration and the deceleration of the rotation of the rotary is greater than an absolute value of acceleration and deceleration of the rotary during image formation.

7. An image forming apparatus comprising:
a developing unit configured to develop an image using a developer;
a rotary rotatably supported and configured to accommodate the developing unit and a cartridge containing a developer to be supplied to the developing unit;
a vibration mechanism configured to come into contact with and move away from the rotary and impart vibration to the rotary; and
a controller configured to control the vibration of the vibration mechanism,
the controller comprises:
at least one memory storing instructions; and
at least one processor that is in communication with the at least one memory and that, when executing the instructions, cooperates with the at least one memory to execute processing, and
the processing includes controlling the vibration mechanism to impart vibration to the rotary during a period in which the development unit is not developing an image.

8. The image forming apparatus according to claim 7,
wherein the vibration mechanism is a cam configured to separate the rotary from a photosensitive drum on which the image developed by the developing unit is to be formed, and the rotary is vibrated by a rotation of the cam.

9. The image forming apparatus according to claim 7,
wherein the vibration mechanism is a vibration actuator in contact with the rotary.

10. The image forming apparatus according to claim 7,
wherein the developing unit has an opening for receiving the developer supplied from the cartridge, and the opening has a sealing member preventing the developer from moving from the developing unit to the cartridge.
